(19) United States
(12) Patent Application Publication
(10) Pub. No.: US 2012/0194707 A1
(43) Pub. Date: Aug. 2, 2012

(54) IMAGE PICKUP APPARATUS, IMAGE REPRODUCTION APPARATUS, AND IMAGE PROCESSING APPARATUS

(75) Inventors: Kanichi KOYAMA, Osaka (JP); Masahiro YOKOHATA, Osaka (JP)

(73) Assignee: SANYO ELECTRIC CO., LTD., Osaka (JP)

(21) Appl. No.: 13/362,610

(22) Filed: Jan. 31, 2012

(30) Foreign Application Priority Data
Jan. 31, 2011 (JP) 2011-018449

(51) Int. Cl. G06K 9/40; H04N 5/262

(52) U.S. Cl. 348/240.1; 348/239; 382/255; 348/E05.051

(57) ABSTRACT

An image pickup apparatus includes a target image generating portion that generates a target image by photography using optical zoom and digital zoom, and an output image generating portion that generates an output image by performing image processing on the target image. An entire image region of the target image includes a first image region and a second image region having a focus degree lower than that of the first image region. The image processing includes a blurring process for blurring an image in the second image region of the target image, and the output image generating portion performs the blurring process in accordance with a magnification of the digital zoom.

### CROSS-REFERENCE TO RELATED APPLICATIONS

This nonprovisional application claims priority under 35 U.S.C. §119(a) on Patent Application No. 2011-018449 filed in Japan on Jan. 31, 2011, the entire contents of which are hereby incorporated by reference.

### BACKGROUND OF THE INVENTION

1. Field of the Invention

The present invention relates to an image pickup apparatus for photographing images, an image reproduction apparatus for reproducing images, and an image processing apparatus for performing image processing.

2. Description of Related Art

In an image pickup apparatus such as a digital camera, both optical zoom and digital zoom are usually used for realizing high magnification zoom. Using both the optical zoom and the digital zoom, the product of the optical zoom magnification and the digital zoom magnification is obtained as an output zoom magnification so that high magnification zoom can be realized.

In this type of image pickup apparatus, when the output zoom magnification is increased from one, as illustrated in FIG. 41, usually, the digital zoom magnification is kept to be one while the optical zoom magnification is first increased from one to an upper limit magnification (five in an example of FIG. 41). After the optical zoom magnification reaches the upper limit magnification, the digital zoom magnification is increased from one. A magnification region for performing angle of view adjustment of a taken image using adjustment of the optical zoom magnification can be called an optical zoom region, and a magnification region for performing the angle of view adjustment of the taken image using adjustment of the digital zoom magnification can be called an digital zoom region.

Note that there is a method of blurring a background by image processing.

Here, the taken image can include a focused subject that is in focus and an out-of-focus subject that is not focused (background subject). If the optical zoom magnification is increased in a state where a noted subject is in focus, a focal length of the image pickup portion changes along with an increase of the optical zoom magnification, a blur amount of the out-of-focus subject also changes along with the change of the focal length. As illustrated in FIG. 42, if the optical zoom magnification is increased in a state where the noted subject is continuously in focus (in a state where the focused subject distance is fixed), the blur amount of the out-of-focus subject is monotonously increased.

On the other hand, the digital zoom is realized by trimming without a change of focal length. Therefore, when the digital zoom magnification is increased, a size of each subject image in the taken image is increased, but the blur amount of the out-of-focus subject is not changed.

Therefore, when the output zoom magnification is increased, the blur amount is gradually increased in the optical zoom region, but after changing from the optical zoom region to the digital zoom region, the blur amount does not change in the taken image. Therefore, if the taken image in the digital zoom region is provided to a user as it is, the user may have a wrong feeling. Otherwise, the user may not be satisfied with that a change of image quality accompanying a change of the output zoom magnification cannot be obtained. It is considered that this wrong feeling or the like will be relieved if the change of image quality obtained by the optical zoom and the change of image quality obtained by the digital zoom are similar to each other, which will be a merit for the user.

Similar thing can be said also in a reproduction step or the like of the image. After the image is photographed, the angle of view adjustment can be performed by trimming. For instance, if a reproduction enlarging magnification in the reproduction is set to be larger than one, enlarging reproduction is performed via the trimming. The decrease of angle of view by trimming after finishing photography functions also as substitute means for decreasing the angle of view by the optical zoom that cannot be or is not performed during photography. Therefore, when the angle of view is decreased by the trimming, an effect as if the angle of view adjustment had been performed by the optical zoom can be obtained, which will be a great merit for the user.

### SUMMARY OF THE INVENTION

An image pickup apparatus according to the present invention includes a target image generating portion that generates a target image by photography using optical zoom and digital zoom, and an output image generating portion that generates an output image by performing image processing on the target image. An entire image region of the target image includes a first image region and a second image region having a focus degree lower than that of the first image region. The image processing includes a blurring process for blurring an image in the second image region of the target image, and the output image generating portion performs the blurring process in accordance with a magnification of the digital zoom.

An image reproduction apparatus according to the present invention includes a target image generating portion that generates a target image by enlarging an input image in accordance with a designated reproduction enlarging magnification, an output image generating portion that generates an output image by performing image processing on the target image, and a display portion that displays the output image. An entire image region of the target image includes a first image region and a second image region having a focus degree lower than that of the first image region. The image processing includes a blurring process for blurring an image in the second image region of the target image, and the output image generating portion performs the blurring process in accordance with the reproduction enlarging magnification. An image processing apparatus according to the present invention includes a target image generating portion that sets a clipping frame for designating a part of an input image and extracts an image in the clipping frame so as to generate a target image, and an output image generating portion that performs image processing on the target image so as to generate an output image. The image processing includes a blurring process for blurring an image of a subject at an out-of-focus distance, and the output image generating portion performs the blurring process in accordance with a size of the clipping frame.

### BRIEF DESCRIPTION OF THE DRAWINGS

FIG. 1 is a schematic general block diagram of an image pickup apparatus according to an embodiment of the present invention.

FIG. 2 is an internal block diagram of the image pickup portion illustrated in FIG. 1.

FIGS. 3A to 3D are diagrams illustrating meanings of focusing, a depth of field, a subject distance, and the like.

FIG. 4 is a diagram illustrating meaning of an original image.

FIG. 5 is a block diagram of a part related particularly to an action according to a first example of the present invention.

FIG. 6 is a diagram illustrating electronic zoom according to the first example of the present invention.

FIG. 7 is a diagram illustrating a positional relationship among a plurality of subjects and the image pickup apparatus supposed in the first example of the present invention.

FIG. 8 is a diagram illustrating a relationship among the original image, a target image, an optical zoom magnification, and the like, according to the first example of the present invention.

FIG. 9 is a diagram illustrating a relationship among an output zoom magnification (ZF_{OUT}), an optical zoom magnification (ZF_{OPT}), and an electronic zoom magnification (ZF_{EL}), according to the first example of the present invention.

FIG. 10 is a diagram illustrating a relationship between the optical zoom magnification and a target blur amount, according to the first example of the present invention.

FIG. 11 is a diagram illustrating blur amount characteristic information according to the first example of the present invention.

FIG. 12A is a diagram illustrating a relationship between the output zoom magnification and the process-blurring amount, and FIG. 12B is a diagram illustrating a relationship between the electronic zoom magnification and the process-blurring amount, according to the first example of the present invention.

FIG. 13 is a diagram illustrating a relationship between the output zoom magnification and the target blur amount on the output image according to the first example of the present invention.

FIG. 14 is a flowchart illustrating an action procedure of the image pickup apparatus in a photographing mode according to the first example of the present invention.

FIG. 15 is a diagram illustrating a variation example of the relationship among the output zoom magnification, the optical zoom magnification, and the electronic zoom magnification according to the first example of the present invention.

FIG. 16 is a block diagram of a portion related to RAW zoom according to a second example of the present invention.

FIGS. 17A and 17B are diagrams illustrating the RAW zoom according to the second example of the present invention.

FIG. 18 is a block diagram of a portion related particularly to an action according to the second example of the present invention.

FIG. 19 is a diagram illustrating a relationship among the output zoom magnification, the optical zoom magnification, and the RAW zoom magnification (ZF_{RAW}) according to the second example of the present invention.

FIG. 20A is a diagram illustrating a relationship between the output zoom magnification and the process-blurring amount, and FIG. 20B is a diagram illustrating a relationship between the RAW zoom magnification and the process-blurring amount, according to the second example of the present invention.

FIG. 21 is a flowchart illustrating an action procedure of the image pickup apparatus in the photographing mode according to the second example of the present invention.

FIG. 22 is a block diagram of a portion related particularly to an action according to a third example of the present invention.

FIG. 23 is a diagram illustrating a relationship among an image to be reproduced, a clipped image, and the target image according to the third example of the present invention.

FIG. 24 is a diagram illustrating a relationship between reproduction enlarging magnification (EF_{REP}) and the process-blurring amount according to the third example of the present invention.

FIG. 25 is a diagram illustrating a relationship between the reproduction enlarging magnification and the target blur amount on the output image according to the third example of the present invention.

FIG. 26 is a flowchart illustrating an action procedure of the image pickup apparatus in a reproducing mode according to the third example of the present invention.

FIG. 27 is a block diagram of a portion related particularly to an action according to a fourth example of the present invention.

FIG. 28 is a diagram illustrating the input image and the target image according to the fourth example of the present invention.

FIG. 29 is a diagram illustrating a structure of an image file according to the fourth example of the present invention.

FIG. 30 is a diagram illustrating a manner in which distance data is output from a subject distance detecting portion according to the fourth example of the present invention.

FIGS. 31A and 31B are diagrams illustrating examples of an input image and a distance map according to the fourth example of the present invention.

FIG. 32 is a diagram illustrating a positional relationship among a plurality of subjects and the image pickup apparatus supposed in the fourth example of the present invention.

FIG. 33 is a diagram illustrating examples of the input image, the target image, and the output image according to the fourth example of the present invention.

FIGS. 34A and 34B are diagrams illustrating relationships between the difference distance and the blur amount on the input image or the target image according to the fourth example of the present invention.

FIG. 35 is a diagram illustrating a positional relationship among a plurality of subjects and the image pickup apparatus supposed in the fourth example of the present invention.

FIG. 36 is a diagram illustrating a depth of field range of the input image, a depth of field range of the target image, and a depth of field range of the output image supposed in the fourth example of the present invention.

FIG. 37 is a diagram illustrating a relationship between the difference distance and the process-blurring amount according to the fourth example of the present invention.

FIG. 38A is a diagram illustrating a relationship between the difference distance and the process-blurring amount in a case where a size of a trimming frame is relatively large, and FIG. 38B is a diagram illustrating a relationship between the difference distance and the process-blurring amount in a case where a size of a trimming frame is relatively small, according to the fourth example of the present invention.

FIG. 39 is a flowchart illustrating an action procedure of the image pickup apparatus in the reproducing mode according to the fourth example of the present invention.

FIG. 40 is a diagram illustrating a digital focus portion according to the fourth example of the present invention.

FIG. 41 is a diagram illustrating a relationship among the output zoom magnification, the optical zoom magnification, and the digital zoom magnification according to a conventional technique.

FIG. 42 is a diagram illustrating a relationship between the output zoom magnification and the blur amount of the out-of-focus subject according to a conventional technique.

### DETAILED DESCRIPTION OF THE PREFERRED EMBODIMENTS

Hereinafter, examples of an embodiment of the present invention are described specifically with reference to the attached drawings. In the drawings to be referred to, the same part is denoted by the same numeral or symbol, and overlapping description of the same part is omitted as a rule. Note that in this specification, for simple description, a name of information, physical quantity, state quantity, a member or the like corresponding to the numeral or symbol may be shortened or omitted by adding the numeral or symbol referring to the information, the physical quantity, the state quantity, the member or the like. For instance, when an optical zoom magnification is denoted by symbol ZF_{OPT}, the optical zoom magnification ZF_{OPT} may be expressed by a magnification ZF_{OPT} or simply by ZF_{OPT}.

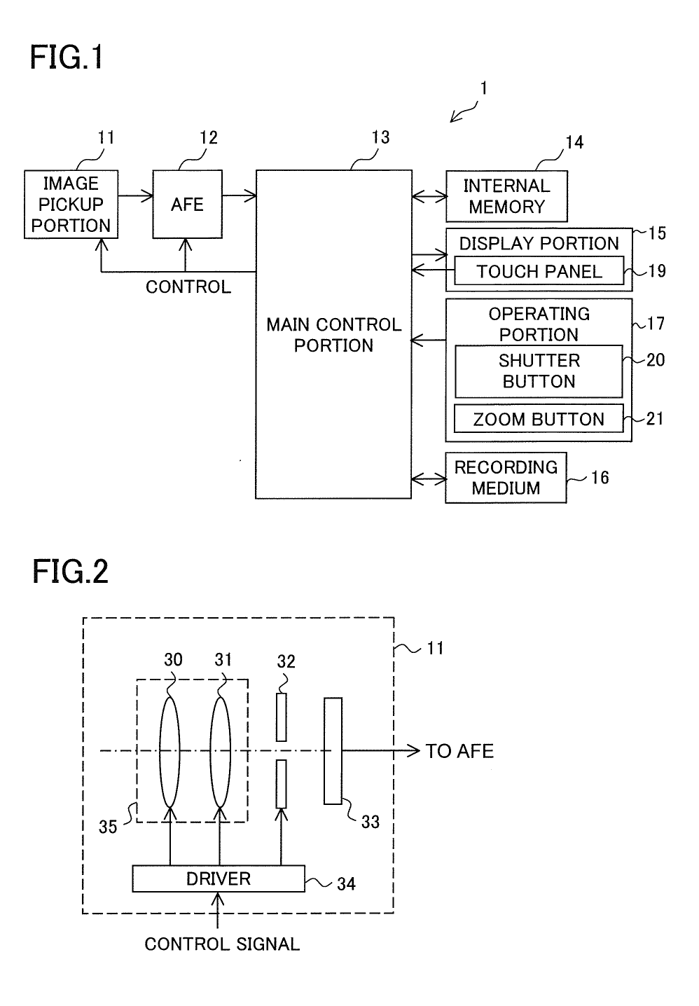

FIG. 1 is a schematic general block diagram of an image pickup apparatus 1 according to an embodiment of the present invention. The image pickup apparatus 1 is a digital video camera that can take and record still images and moving images. However, the image pickup apparatus 1 may be a digital still camera that can take and record only still images. In addition, the image pickup apparatus 1 may be one that is incorporated in a mobile terminal such as a mobile phone.

The image pickup apparatus 1 includes an image pickup portion 11, an analog front end (AFE) 12, a main control portion 13, an internal memory 14, a display portion 15, a recording medium 16, and an operating portion 17. Note that the display portion 15 can be interrupted to be disposed in an external device (not shown) of the image pickup apparatus 1.

The image pickup portion 11 photographs a subject using an image sensor. FIG. 2 is an internal block diagram of the image pickup portion 11. The image pickup portion 11 includes an optical system 35, an aperture stop 32, an image sensor (solid-state image sensor) 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 for adjusting an angle of view of the image pickup portion 11 and a focus lens 31 for focusing. The zoom lens 30 and the focus lens 31 can move in an optical axis direction. Based on a control signal from the main control portion 13, positions of the zoom lens 30 and the focus lens 31 in the optical system 35 and an opening degree of the aperture stop 32 are controlled.

The image sensor 33 is constituted of a plurality of light receiving pixels arranged in horizontal and vertical directions. The light receiving pixels of the image sensor 33 perform photoelectric conversion of an optical image of the subject entering through the optical system 35 and the aperture stop 32, so as to deliver an electric signal obtained by the photoelectric conversion to the analog front end (AFE) 12.

The AFE 12 amplifies an analog signal output from the image pickup portion 11 (image sensor 33) and converts the amplified analog signal into a digital signal so as to deliver the digital signal to the main control portion 13. An amplification degree of the signal amplification in the AFE 12 is controlled by the main control portion 13. The main control portion 13 performs image processing on the image expressed by the output signal of the AFE 12 and generates an image signal of the image after the image processing. The main control portion 13 also has a function as a display control portion that controls display content of the display portion 15 so as to perform control necessary for the display on the display portion 15.

The internal memory 14 is constituted of a synchronous dynamic random access memory (SDRAM) or the like and temporarily stores various data generated in the image pickup apparatus 1.

The display portion 15 is a display device having a display screen such as a liquid crystal display panel so as to display taken images or images recorded in the recording medium 16 under control of the main control portion 13. In this specification, when referred to simply as a display or a display screen, it means the display or the display screen of the display portion 15. The display portion 15 is equipped with a touch panel 19, so that a user can issue a specific instruction to the image pickup apparatus 1 by touching the display screen of the display portion 15 with a touching member (such as a finger or a touch pen). Note that it is possible to omit the touch panel 19.

The recording medium 16 is a nonvolatile memory such as a card-like semiconductor memory or a magnetic disk so as to record an image signal of the taken image under control of the main control portion 13. The operating portion 17 includes a shutter button 20 for receiving an instruction to take a still image, a zoom button 21 for receiving an instruction to change a zoom magnification and the like, so as to receive various operations from the outside. Operational content of the operating portion 17 is sent to the main control portion 13. The operating portion 17 and the touch panel 19 can be called a user interface for receiving user's arbitrary instruction and operation. The shutter button 20 and the zoom button 21 may be buttons on the touch panel 19.

Action modes of the image pickup apparatus 1 include a photographing mode in which images (still images or moving images) can be taken and recorded, and a reproducing mode in which images (still images or moving images) recorded in the recording medium 16 can be reproduced and displayed on the display portion 15. Transition between the modes is performed in accordance with an operation to the operating portion 17.

In the photographing mode, a subject is photographed periodically at a predetermined frame period so that taken images of the subject are sequentially obtained. An image signal expressing an image is also referred to as image data. The image signal contains a luminance signal and a color difference signal, for example. However, in this specification, an output signal of each light receiving pixel of the image sensor 33 may be also referred to as image data. Image data of a certain pixel may be referred to as a pixel signal. A size of a certain image or a size of an image region may be referred to as an image size. An image size of a noted image or a noted image region can be expressed by the number of pixels forming the noted image or the number of pixels belonging to the noted image region. Note that in this specification, image data of a certain image may be referred to simply as an image.

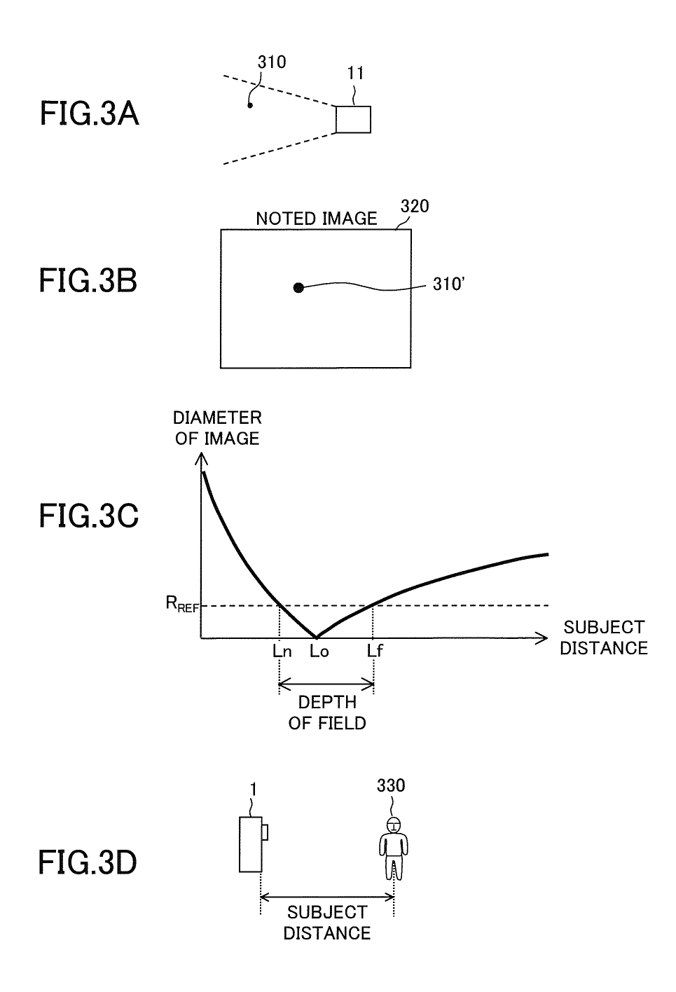

With reference to FIGS. 3A to 3D, meanings of focusing and the like are described. As illustrated in FIG. 3A, it is supposed that an ideal point light source 310 is included as a subject in a photographing range of the image pickup portion 11. In the image pickup portion 11, incident light from the point light source 310 forms an image at an imaging point via the optical system 35. If the imaging point is on an imaging surface of the image sensor 33, the diameter of the image of the point light source 310 on the imaging surface is substantially zero and is smaller than a permissible diameter of circle of confusion of the image sensor 33. On the other hand, if the imaging point is not on the imaging surface of the image sensor 33, the optical image of the point light source 310 is blurred on the imaging surface. As a result, the diameter of the image of the point light source 310 on the imaging surface can be larger than the permissible diameter of circle of confusion. If the diameter of the image of the point light source 310 on the imaging surface is the permissible diameter of circle of confusion or smaller, the subject as the point light source 310 is focused on the imaging surface. If the diameter of the image of the point light source 310 on the imaging surface is larger than the permissible diameter of circle of confusion, the subject as the point light source 310 is not focused on the imaging surface.

In similar consideration, as illustrated in FIG. 3B, if an image 310′ of the point light source 310 is included as a subject image in a noted image 320 as an arbitrary two-dimensional image, and if a diameter of the image 310′ is smaller than or equal to a reference diameter R_{REF} corresponding to the permissible diameter of circle of confusion, the subject as the point light source 310 is focused in the noted image 320. If the diameter of the image 310′ is larger than the reference diameter R_{REF}, the subject as the point light source 310 is not focused in the noted image 320. The reference diameter R_{REF} is the permissible diameter of circle of confusion in the noted image 320. In the noted image 320, a subject that is focused is referred to as a focused subject, and a subject that is not focused is referred to as an out-of-focus subject. In the entire image region of the noted image 320, an image region where image data of the focused subject exists is referred to as a focused region, and an image region where image data of the out-of-focus subject exists is referred to as an out-of-focus region.

In addition, an indicator corresponding to the diameter of the image 310′ is referred to as a focus degree. In the noted image 320, as the diameter of the image 310′ is larger, the focus degree of the subject as the point light source 310 (namely, the focus degree of the image 310′) is lower. As the diameter of the image 310′ is smaller, the focus degree of the subject as the point light source 310 (namely, the focus degree of the image 310′) is higher. Therefore, the focus degree in the out-of-focus region is lower than the focus degree in the focused region. Note that an arbitrary image mentioned in this specification is a two-dimensional image unless otherwise noted.

A distance in the real space between an arbitrary subject 330 and the image pickup apparatus 1 (more specifically, the image sensor 33) is referred to as a subject distance (see FIG. 3D). If the arbitrary subject 330 is positioned in the depth of field of the noted image 320 (namely, if the subject distance of the subject 330 is within the depth of field of the noted image 320), the subject 330 is a focused subject in the noted image 320. If the subject 330 is not positioned in the depth of field of the noted image 320 (namely, if the subject distance of the subject 330 is not within the depth of field of the noted image 320), the subject 330 is an out-of-focus subject in the noted image 320.

As illustrated in FIG. 3C, a range of the subject distance in which the diameter of the image 310′ is the reference diameter R_{REF} or smaller is the depth of field of the noted image 320. A focus reference distance Lo, a near point distance Ln, and a far point distance Lf of the noted image 320 are within the depth of field of the noted image 320. A subject distance corresponding to a minimum value of the diameter of the image 310′ is the focus reference distance Lo of the noted image 320. A minimum distance and a maximum distance in the depth of field of the noted image 320 are the near point distance Ln and the far point distance Lf, respectively. A length between the near point distance Ln and the far point distance Lf is referred to as a magnitude of the depth of field.

Hereinafter, a plurality of examples concerning structures and actions or other techniques of the image pickup apparatus 1 are described. Contents described in an example can be applied to other examples unless otherwise noted and as long as no contradiction arises.

### First Example

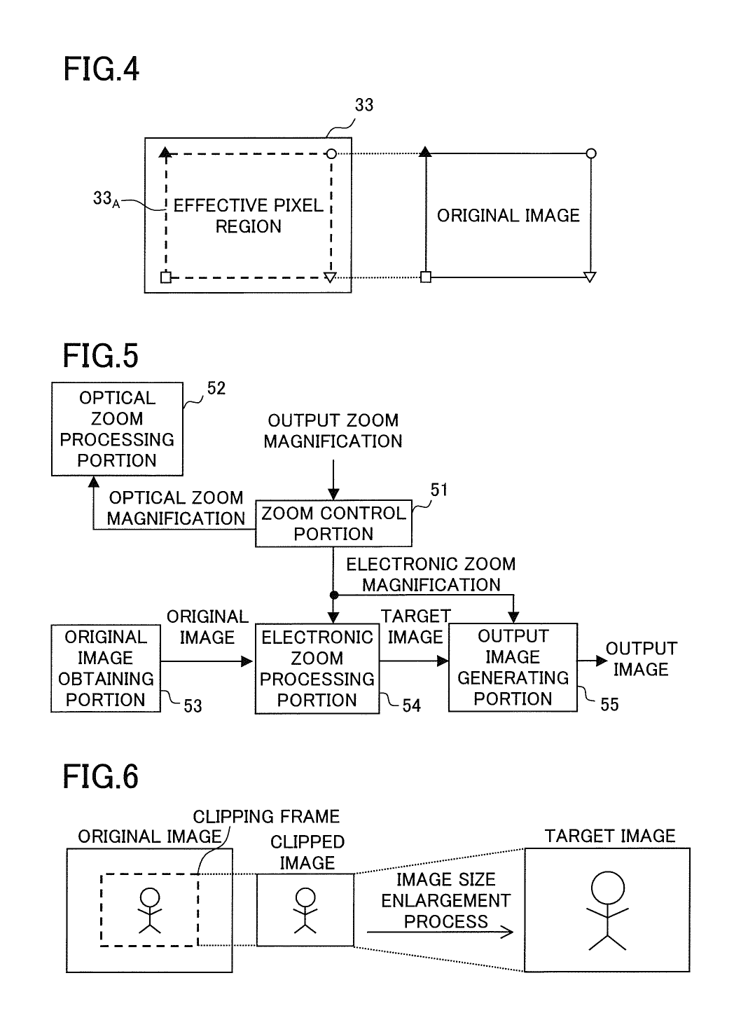

A first example of the present invention is described. As illustrated in FIG. 4, in the entire region of the image sensor 33 in which the light receiving pixels are arranged, there is set a rectangular effective pixel region 33_{A}. Each of the light receiving pixels performs photoelectric conversion of the optical image of the subject entering through the optical system 35 and the aperture stop 32, so as to output an electric signal obtained by the photoelectric conversion as a light receiving pixel signal.

An image constituted of the light receiving pixel signals output from the light receiving pixels in the effective pixel region 33_{A} is referred to as an original image. In the first example, the angle of view of the original image is supposed to be the same as the angle of view of the image formed in the entire effective pixel region 33_{A}. The angle of view of the original image is an angle indicating a range of a photographing space expressed by the original image (the same is true for the angle of view of any other image than the original image).

FIG. 5 is a block diagram of a portion related particularly to an action according to the first example. In the image pickup apparatus 1 (for example, in the main control portion 13), there can be disposed a zoom control portion 51 that sets the optical zoom magnification and the electronic zoom magnification from an output zoom magnification, an optical zoom processing portion 52 that performs optical zoom by driving the zoom lens 30 in accordance with the optical zoom magnification, an original image obtaining portion 53 that obtains image data of the original image, an electronic zoom processing portion 54 that generates a target image from the original image by electronic zoom with the electronic zoom magnification set by the zoom control portion 51, and an output image generating portion 55 that generates an output image by performing image processing according to the electronic zoom magnification on the target image.

The user can use the zoom button 21 so as to perform a zoom operation for designating the output zoom magnification. The zoom control portion 51 sets the optical zoom magnification and the electronic zoom magnification from the output zoom magnification designated in the zoom operation. The output zoom magnification, the optical zoom magnification, and the electronic zoom magnification are denoted by symbols ZF_{OUT}, ZF_{OPT}, and ZF_{EL}, respectively. In the first example, the optical zoom magnification and the electronic zoom magnification are set so that the equation ZF_{OUT}=ZF_{OPT}×ZF_{EL} is satisfied.

The optical zoom processing portion 52 controls a position of the zoom lens 30 so that the angle of view of the original image becomes the angle of view according to the optical zoom magnification set by the zoom control portion 51. In other words, by controlling the position of the zoom lens 30 in accordance with the optical zoom magnification, the optical zoom processing portion 52 determines the angle of view of the image formed on the effective pixel region 33_{A} of the image sensor 33. Here, it is supposed that when the optical zoom magnification becomes k₁ times a given magnification, the angle of view of the image formed on the effective pixel region 33_{A} becomes 1/k₁ times in each of the horizontal and vertical directions of the image sensor 33 (k₁ is a positive number, for example, twice). However, it is possible to define the magnification by an area ratio and to consider that when the optical zoom magnification becomes k₁² times a given magnification, the angle of view of the image formed on the effective pixel region 33_{A} becomes 1/k₁ times in each of the horizontal and vertical directions of the image sensor 33.

The original image obtaining portion 53 obtains image data of the original image taken with the optical zoom magnification set by the zoom control portion 51. It is possible to consider structural elements of the original image obtaining portion 53 include the image sensor 33 and the AFE 12.

The electronic zoom processing portion 54 generates the target image by performing electronic zooming process according to the electronic zoom magnification set by the zoom control portion 51 on the original image. The electronic zooming process means a process of setting a clipping frame having a size corresponding to the electronic zoom magnification in the image region of the original image as illustrated in FIG. 6, so as to generate a target image that is an image obtained by performing image size enlargement process on the image in the clipping frame on the original image (hereinafter, referred to as a clipped image). If the electronic zoom magnification is larger than one, an angle of view of the target image becomes smaller than the angle of view of the original image.

Here, it is supposed that a center position of the original image is the same as a center position of the clipping frame, and an aspect ratio of the original image is the same as an aspect ratio of the clipping frame (namely, an aspect ratio of the clipped image). However, the center position or the aspect ratio may be different between the original image and the clipping frame. Here, it is supposed that when the electronic zoom magnification is k₂, a size of the clipping frame becomes 1/k₂ of a size of the original image in each of the horizontal and vertical directions (k₂≧1). However, it is possible to define the magnification by an area ratio and to consider that when the electronic zoom magnification is k₂², a size of the clipping frame becomes 1/k₂ times a size of the original image in each of the horizontal and vertical directions. If k₂ is larger than one, the clipped image is a part of the original image. If k₂ is equal to one, the clipped image is the original image itself.

The image size of the target image is the same as the image size of the output image, which is predetermined. The predetermined image size of the target image and the output image is referred to as a specified output size. The electronic zoom processing portion 54 performs the above-mentioned image size enlargement process using known resolution conversion (resampling) so that a target image having the specified output size can be obtained. However, if the specified output size is smaller than the image size of the clipped image, instead of the image size enlargement process in which the image size of the clipped image is increased, image size reduction process for reducing the image size of the clipped image is used. In other words, the image size enlargement process or the image size reduction process is performed on the clipped image so that the image size of the clipped image after the image size enlargement process or the image size reduction process becomes the same as the specified output size.

In the example of FIG. 6, it is supposed that the image size of the clipped image that is clipped from the original image is smaller than the specified output size. The specified output size may be the same as the image size of the original image (image size of the effective pixel region 33_{A}). Therefore, the target image is generated by performing the image size enlargement process on the clipped image, in which the number of pixels of the clipped image is increased. If the image size of the clipped image that is clipped from the original image is larger than the specified output size, the target image can be generated by performing the image size reduction process on the clipped image, in which the number of pixels of the clipped image is reduced.

The output image generating portion 55 performs the image processing according to the electronic zoom magnification on the target image so as to generate the output image (details will be described later).

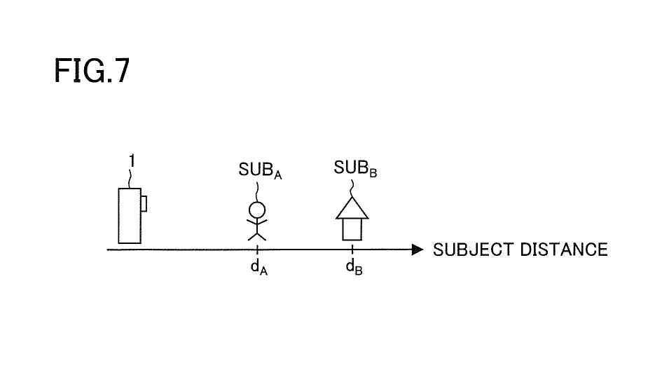

Here, it is supposed that a plurality of subjects exist within the photographing range of the image pickup portion 11 and that the plurality of subjects includes subjects SUB_{A} and SUB_{B}. In addition, as illustrated in FIG. 7, subject distances of the subjects SUB_{A} and SUB_{B} are denoted by symbols d_{A} and d_{B}, respectively (d_{A} is not equal to d_{B}). In the first example, a variable range of the optical zoom magnification ZF_{OPT} is supposed to be one or larger and five or smaller. A variable range of the electronic zoom magnification ZF_{EL} is supposed to be one or larger and two or smaller. As a result, a variable range of the output zoom magnification ZF_{OUT} is supposed to be one or larger and ten or smaller. As a matter of course, it is needless to say that these variable ranges can be changed variously. Note that in the following description, for convenience sake of description, it is supposed that each of the subjects SUB_{A} and SUB_{B} is an ideal point light source, as necessary.

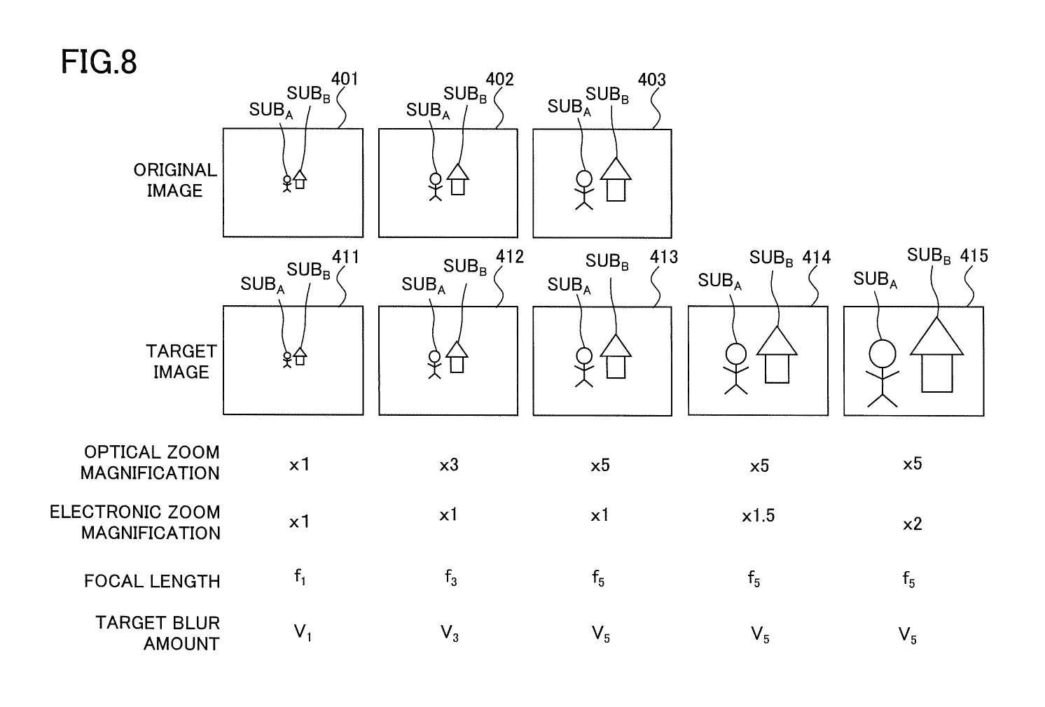

In FIG. 8, an image 401 is an original image when ZF_{OPT}=1 holds, an image 402 is an original image when ZF_{OPT}=3 holds, and an image 403 is an original image when ZF_{OPT}=5 holds. An image 411 is a target image when ZF_{OPT}=1 and ZF_{EL}=1 hold, an image 412 is a target image when ZF_{OPT}=3 and ZF_{EL}=1 hold, an image 413 is a target image when ZF_{OPT}=5 and ZF_{EL}=1 hold, an image 414 is a target image when ZF_{OPT}=5 and ZF_{EL}=1.5 hold, and an image 415 is a target image when ZF_{OPT}=5 and ZF_{EL}=2 hold. Images of the subjects SUB_{A} and SUB_{B} appear in each of the original images 401 to 403 and in each of the target images 411 to 415. Symbols f₁, f₃, and f₅ denote focal lengths of the image pickup portion 11 in cases where the optical zoom magnification is one, three, and five, respectively. When a position of the zoom lens 30 is changed, the focal length is changed. Symbols V₁, V₃, and V₅ illustrated in FIG. 8 will be described later.

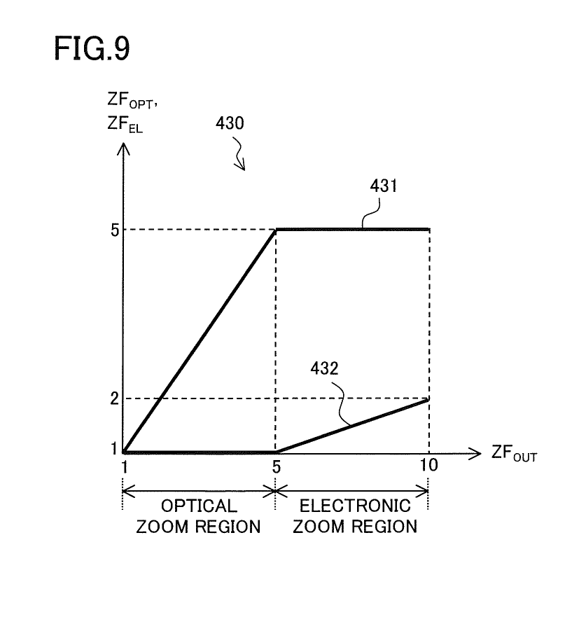

FIG. 9 illustrates a relationship among the magnification ZF_{OPT}, ZF_{EL}, and ZF_{OUT} supposed in the first example. In FIG. 9, a bent line 431 indicates a relationship between ZF_{OPT} and ZF_{OUT}, and a bent line 432 indicates a relationship between ZF_{EL} and ZF_{OUT}. The relationship among the magnifications ZF_{OPT}, ZF_{EL}, and ZF_{OUT} according to the bent lines 431 and 432 is referred to as a magnification relationship 430. In the magnification relationship 430, when 1≦ZF_{OUT}≦5 holds, ZF_{OPT}=ZF_{OUT} and ZF_{EL}=1 are satisfied. In the magnification relationship 430, when 5<ZF_{OUT}≦10 holds, ZF_{OPT}=5 and ZF_{EL}=ZF_{OUT}/5 are satisfied. In other words, if 1≦ZF_{OUT}≦5 holds, the angle of view of the target image is adjusted by adjustment of only the optical zoom magnification. If 5<ZF_{OUT}≦10 holds, the angle of view of the target image is adjusted by adjustment of only the electronic zoom magnification. A magnification region for adjusting the angle of view of the target image using the adjustment of the optical zoom magnification is referred to as an optical zoom region. A magnification region for adjusting the angle of view of the target image using the adjustment of the electronic zoom magnification is referred to as an electronic zoom region. In the magnification relationship 430, the optical zoom region and the electronic zoom region are completely separated.

When an arbitrary original image is taken, it is supposed that the subject SUB_{A} is a focused subject while the subject SUB_{B} is an out-of-focus subject. In other words, regardless of the optical zoom magnification, it is supposed that the subject SUB_{A} is always a focused subject while the subject SUB_{B} is always an out-of-focus subject in the original image and the target image. Then, in the arbitrary original image and the arbitrary target image, the blur amount of the subject SUB_{A} becomes a minimum value, while the blur amount of the subject SUB_{B} is larger than a blur amount of the subject SUB_{A}. In the noted image 320 as an arbitrary two-dimensional image (see FIG. 3B), the blur amount of the noted subject is an indicator indicating a degree of blur of a noted subject on the noted image 320. As the degree of blur of the noted subject is larger, the blur amount of the noted subject is larger. In addition, as the focus degree of the noted subject is lower, the blur amount of the noted subject is larger. The noted subject is SUB_{A} or SUB_{B}, for example. Therefore, for example, when it is supposed that each of the subjects SUB_{A} and SUB_{B} is an ideal point light source, it is possible to consider that diameters of images of the subjects SUB_{A} and SUB_{B} in the image 320 are blur amounts of the subjects SUB_{A} and SUB_{B}, respectively.

A blur amount of the subject SUB_{B} with respect to the blur amount of the subject SUB_{A} or the reference diameter R_{REF} is particularly referred to as a target blur amount (see FIG. 3C). The target blur amount can be considered to be a ratio of “the blur amount of the subject SUB_{B}” to “the blur amount of the subject SUB_{A} or the reference diameter R_{REF}”. Further, when the optical zoom magnification is p, the target blur amount on the obtained original image or the target image is denoted by symbol Vₚ (p is one or larger real number). Therefore, for example, the target blur amount in the original image 401 and the target image 411 is denoted by V₁. The target blur amount in the original image 402 and the target image 412 is denoted by V₃, and the target blur amount in the original image 403 and the target images 413 to 415 is denoted by V₅. Here, V₁<V₃<V₅ is satisfied.

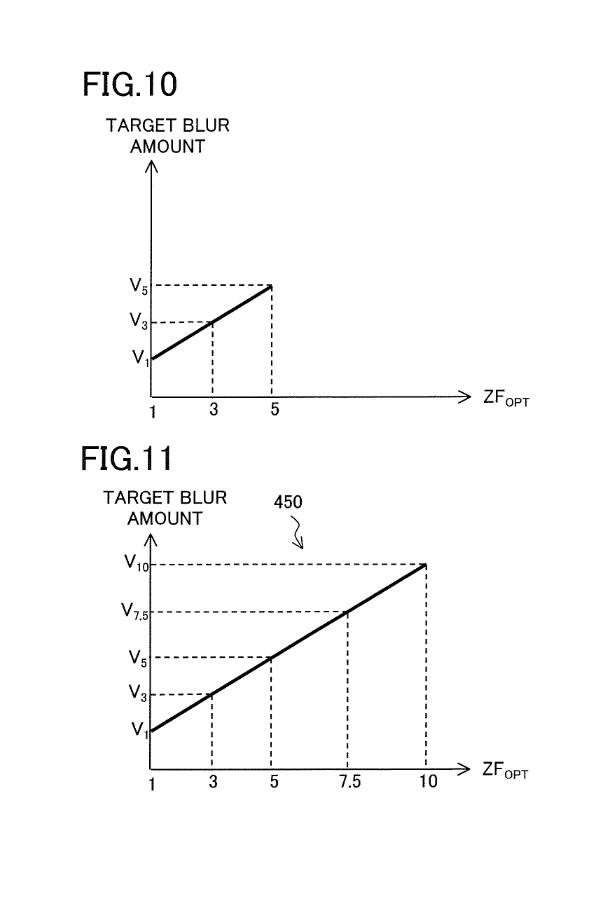

FIG. 10 illustrates a relationship between the optical zoom magnification ZF_{OPT} and the target blur amount. A change of the optical zoom magnification corresponds to a change of a focal length of the image pickup portion 11. When the focal length changes, the target blur amount also changes. For instance, as illustrated in FIG. 10, the target blur amount increases monotonously along with an increase of the optical zoom magnification. However, when the electronic zoom magnification is increased, a size of each subject image on the target image is increased (see target images 413 to 415 of FIG. 8), but the target blur amount is not changed. Therefore, when the output zoom magnification ZF_{OUT} is increased from one to ten, the target blur amount is increased gradually in the optical zoom region. However, after the zoom region is changes from the optical zoom region to the electronic zoom region, even if the output zoom magnification ZF_{OUT} is increased, the target blur amount becomes fixed on the target image. Therefore, if the target image is provided to the user as it is, the user may have a wrong feeling. Otherwise, the user may not be satisfied with that a change of image quality accompanying a change of the output zoom magnification cannot be obtained.

In order to avoid an occurrence of such wrong feeling or the like, the output image generating portion 55 generates the output image by performing image processing according to the electronic zoom magnification (hereinafter, referred to also as specific image processing) on the target image. Image data of the output image can be recorded in the recording medium 16, and the output image can be displayed on the display portion 15. However, it is also possible to record image data of the original image or the target image in the recording medium 16, and it is also possible to display the original image or the target image on the display portion 15.

When the specific image processing is realized, blur amount characteristic information 450 illustrated in FIG. 11 is used. The upper limit magnification of the optical zoom magnification is actually five, but for convenience sake, it is considered that in the blur amount characteristic information 450, the upper limit magnification of the optical zoom magnification is the same as the upper limit magnification of the output zoom magnification (ten in the first example). Therefore, the target blur amounts for the arbitrary optical zoom magnifications from one to ten are defined in the blur amount characteristic information 450. In other words, the target blur amount Vₚ for an arbitrary real number p satisfying 1≦p≦10 is defined in the blur amount characteristic information 450. Therefore, the output image generating portion 55 can recognize the target blur amount Vₚ for the arbitrary real number p satisfying 1≦p≦10 from the blur amount characteristic information 450. The blur amount characteristic information 450 is given as a function or table data, and a blur amount characteristic information storage portion (not shown) for storing the blur amount characteristic information 450 can be disposed in the main control portion 13 or the like.

The optical zoom magnification is actually changed within the range satisfying 1≦ZF_{OPT}≦5, and the target blur amount for each optical zoom magnification is measured. Thus, the target blur amount Vₚ within the range satisfying 1≦p≦5 can be known correctly. The target blur amount Vₚ within the range satisfying 5<p≦10 is estimated by calculation from the target blur amount Vₚ within the range satisfying 1≦p≦5, and hence the blur amount characteristic information 450 can be generated. As a matter of course, it is possible to determine the target blur amount Vₚ within the range satisfying 1≦p≦10 from optical characteristics of the image pickup portion 11 entirely by calculation. In any case, the blur amount characteristic information 450 indicates a relationship between the target blur amount that is observed when the target image is obtained by using only the optical zoom (namely, that is observed when ZF_{EL} equals one) and the optical zoom magnification.

The entire image region of the target image includes an image region A as a focused region in which image data of the subject SUB_{A} exists, and an image region B as an out-of-focus region in which image data of the subject SUB_{B} exists. In an arbitrary target image, the focus degree of the image region B is lower than the focus degree of the image region A. The specific image processing in the output image generating portion 55 includes a blurring process for blurring the image of the subject SUB_{B} on the target image, namely, the blurring process for blurring the image in the out-of-focus region B of the target image. The blurring process can be realized by a filtering process using a smoothing filter for smoothing an image, for example.

An indicator indicating intensity of blurring in the blurring process is referred to as a process-blurring amount (or a blurring amount simply). The process-blurring amount may be considered to be an amount of blurring added to the image in the image region B of the target image by the blurring process. As the process-blurring amount is larger, the image in the image region B is blurred more strongly. When the blurring process is realized by spatial domain filtering using the smoothing filter, for example, it is preferred to increase a filter size of the smoothing filter (such as a Gaussian filter) to be used for the blurring process along with an increase of the process-blurring amount, and the increase of the filter size enhances blurring intensity.

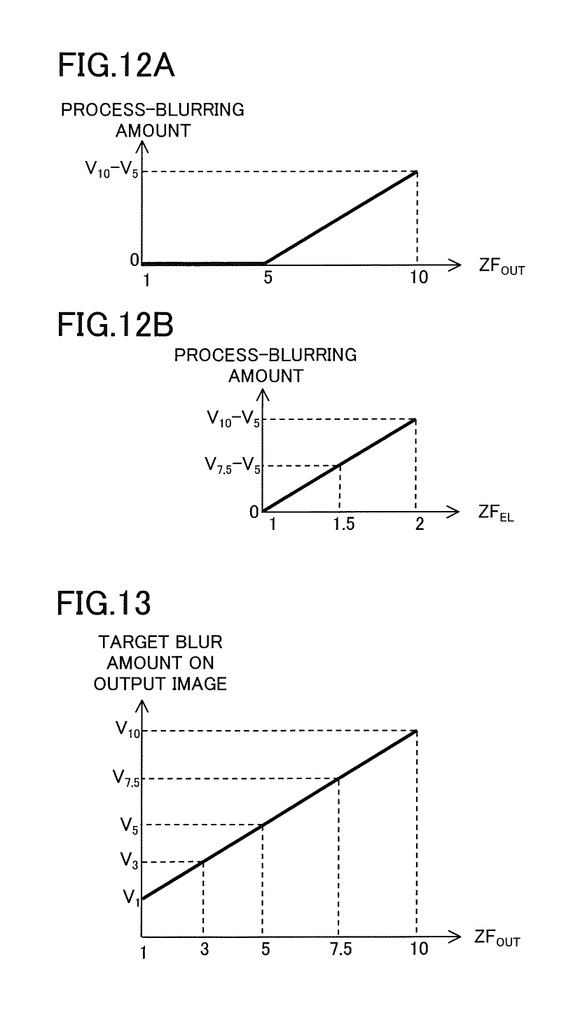

FIG. 12A illustrates a relationship between the output zoom magnification ZF_{OUT} and the process-blurring amount, and FIG. 12B illustrates a relationship between the electronic zoom magnification ZF_{EL} and the process-blurring amount. In addition, FIG. 13 illustrates a relationship between the output zoom magnification ZF_{OUT} and the target blur amount on the output image.

As illustrated in FIGS. 12A and 12B, if the output zoom magnification is five or smaller, namely if the electronic zoom magnification is one, the process-blurring amount is set to zero. In other words, when ZF_{EL} is one, the output image generating portion 55 does not perform the blurring process on the target image but outputs the target image as it is as the output image. On the other hand, if the output zoom magnification is larger than five, namely if the electronic zoom magnification is larger than one, the output image generating portion 55 performs the blurring process on the target image and outputs the target image after the blurring process as the output image. Along with an increase of the output zoom magnification, namely along with an increase of the electronic zoom magnification, the process-blurring amount is increased. Specifically, for example, the output image generating portion 55 sets the process-blurring amount and performs the blurring process based on the electronic zoom magnification ZF_{EL} and the blur amount characteristic information 450, so that the target blur amount on the output image is the same as V_{7.5} when ZF_{EL} is 1.5, and that the target blur amount on the output image is the same as V₁₀ when ZF_{EL} is two. Therefore, the process-blurring amount when ZF_{EL} is 1.5 corresponds to V_{7.5}-V₅, and the process-blurring amount when ZF_{EL} is two corresponds to V₁₀-V₅.

Because the target blur amount depends on subject distances d_{A} and d_{B} of the subjects SUB_{A} and SUB_{B}, the process-blurring amount to be set also depends on the subject distances d_{A} and d_{B}. Therefore, it is preferred to dispose a subject distance detecting portion (not shown) that detects a subject distance of a subject at each pixel of the original image or the target image in the main control portion 13, and to use subject distance information indicating the detection result (namely, a detected value of the subject distance of a subject at each pixel of the original image or the target image) for determining a process-blurring amount for each pixel of the target image (the same is true for the second to fourth examples described later). As a detection method of the subject distance, arbitrary methods including known methods can be used. For instance, a stereo camera or a range sensor may be used for detecting the subject distance. Otherwise, the subject distance may be determined by an estimation process using edge information of the original image or the target image.

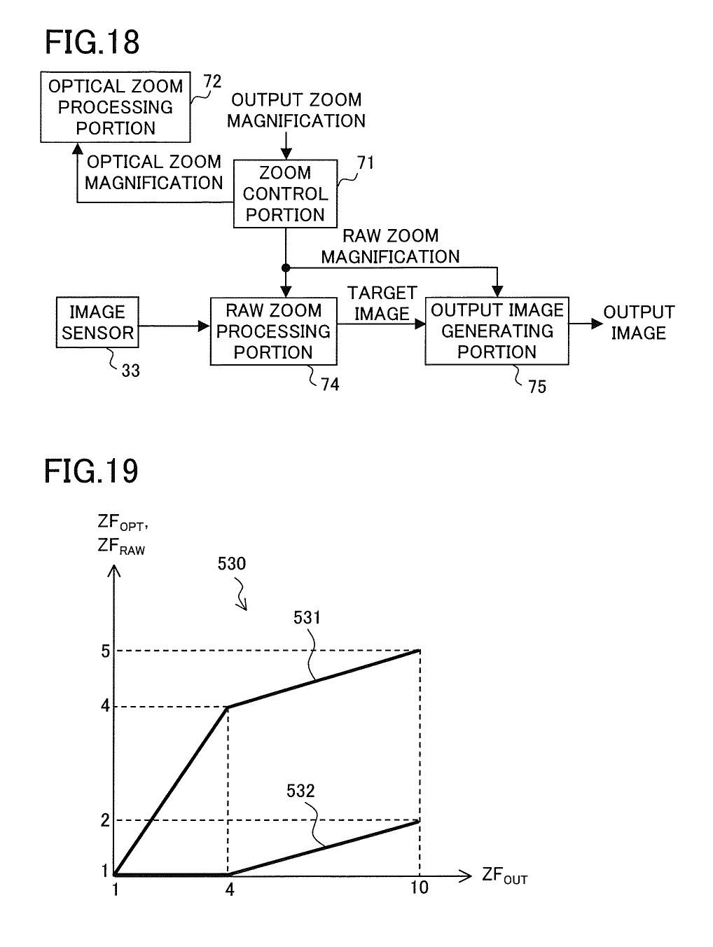

A classification process for classifying a subject at each pixel of the target image into either one of the focused subject and the out-of-focus subject (namely, a classification process for classifying each subject image region of the target image into either one of the focused region and the out-of-focus region) can be performed by the output image generating portion 55 and the output image generating portion 75 described later (see FIG. 18). The output image generating portion 55 (and the output image generating portion 75) can use a result of the classification process to perform the specific image processing.

The classification process can be performed based on a focal length, an aperture stop value, and subject distance information of the image pickup portion 11 when photographing an image to be a base of the target image or the target image. It is because the depth of field of the original image and the target image can be determined based on the focal length and the aperture stop value, and that it is known whether or not the subject distance corresponding to each pixel of the target image is within the depth of field using the subject distance information after the depth of field is determined.

Alternatively, the classification process can be performed based on image data of the target image. For instance, the entire image region of the target image is split into a plurality of small regions, and for each small region, edge intensity in the small region is determined based on image data of the small region. An edge extraction process using an edge extraction filter (such as a differential filter) is performed for each pixel in the small region, and an output value of the edge extraction filter used for each pixel in the small region is accumulated so that the edge intensity of the small region can be determined. Then, small regions having edge intensity of a predetermined reference value or larger are classified into the focused region, while small regions having edge intensity smaller than the reference value are classified into the out-of-focus region, so that the above-mentioned classification process can be realized.

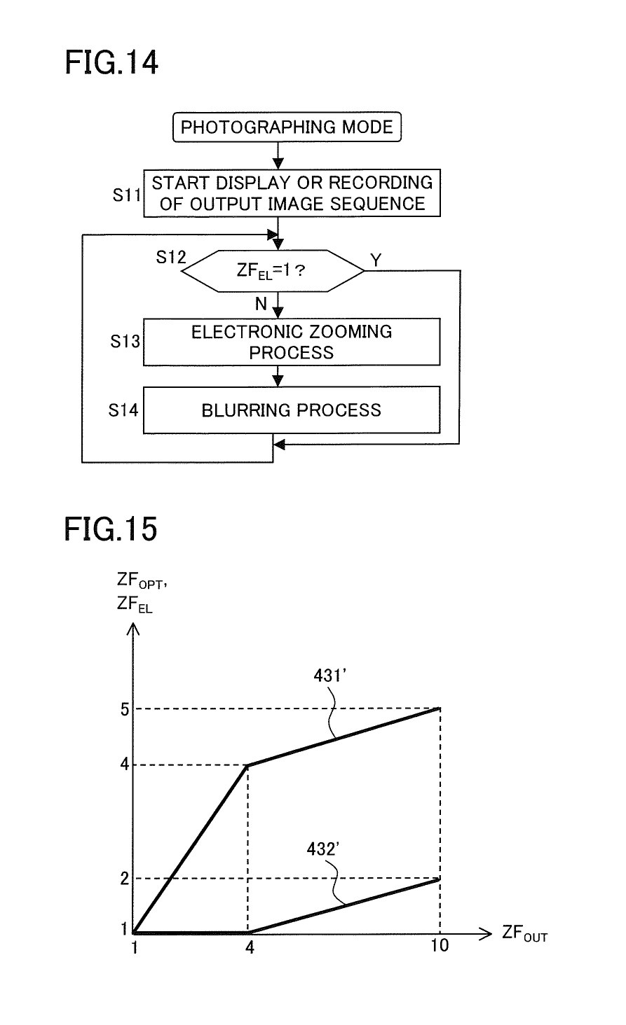

With reference to the flowchart of FIG. 14, an action procedure of the image pickup apparatus 1 in the photographing mode is described. When the image pickup apparatus 1 is powered on, subjects are photographed sequentially at a predetermined frame period, and display of the output image sequence is started (Step S11). When recording instruction is issued, the output image sequence is recorded. The output image sequence means a set of output images arranged in time sequence.

After starting display or recording of the output image sequence, the process of Steps S12 to S14 is repeated while continuing the display or recording of the output image sequence. The user can freely perform the zoom operation to instruct a change of the output zoom magnification at an arbitrary timing. The zoom control portion 51 resets the magnifications ZF_{OPT} and ZF_{EL} in accordance with the relationship of FIG. 9 every time when the output zoom magnification is changed using the zoom button 21. In Step S12, it is decided whether or not the electronic zoom magnification ZF_{EL} is one. In other words, it is decided whether or not the output zoom magnification of the present time point is within the optical zoom region. If the output zoom magnification of the present time point is within the optical zoom region (namely, if ZF_{EL} is one), the output image is generated without performing the electronic zooming process and the blurring process. If the output zoom magnification of the present time point is not within the optical zoom region (namely, if ZF_{EL} is larger than one), in Steps S13 and S14, the electronic zooming process is performed on the original image of the present time point, and further the blurring process is performed to obtain the output image.

According to the first example, in the electronic zoom region too, a blur amount can be obtained as if the optical zoom is used for obtaining the blur amount (the effect as if the angle of view adjustment is performed by the optical zoom can be obtained). Therefore, the situation where the blur amount is not changed in the electronic zoom region can be avoided, and user's wrong feeling or the like generated in such the situation can be relieved.

Note that in the magnification relationship 430 (see FIG. 9) supposed in the above description, the optical zoom region and the electronic zoom region are completely separated, but they may be overlapped partially. In other words, when the output zoom magnification is in a certain range (for example, four to ten), the optical zoom magnification and the electronic zoom magnification may be changed simultaneously in accordance with a change of the output zoom magnification. For instance, as illustrated in FIG. 15, when 1≦ZF_{OUT}≦4 is satisfied, ZF_{OPT}=ZF_{OUT} and ZF_{EL}=1 may be satisfied. When 4<ZF_{OUT}≦10 is satisfied, a relational equation ZF_{OUT}=ZF_{OPT}×ZF_{EL} may be satisfied, and along with an increase of ZF_{OUT} from 4 to 10, ZF_{OPT} may be increased linearly from 4 to 5 while ZF_{EL} is increased linearly from 1 to 2. In FIG. 15, a bent line 431′ indicates a variation example of a relationship between ZF_{OPT} and ZF_{OUT}, and a bent line 432′ indicates a variation example of a relationship between ZF_{EL} and ZF_{OUT}.

### Second Example

A second example of the present invention is described. The contents described in first example can be applied to the second example as long as no contradiction arises.

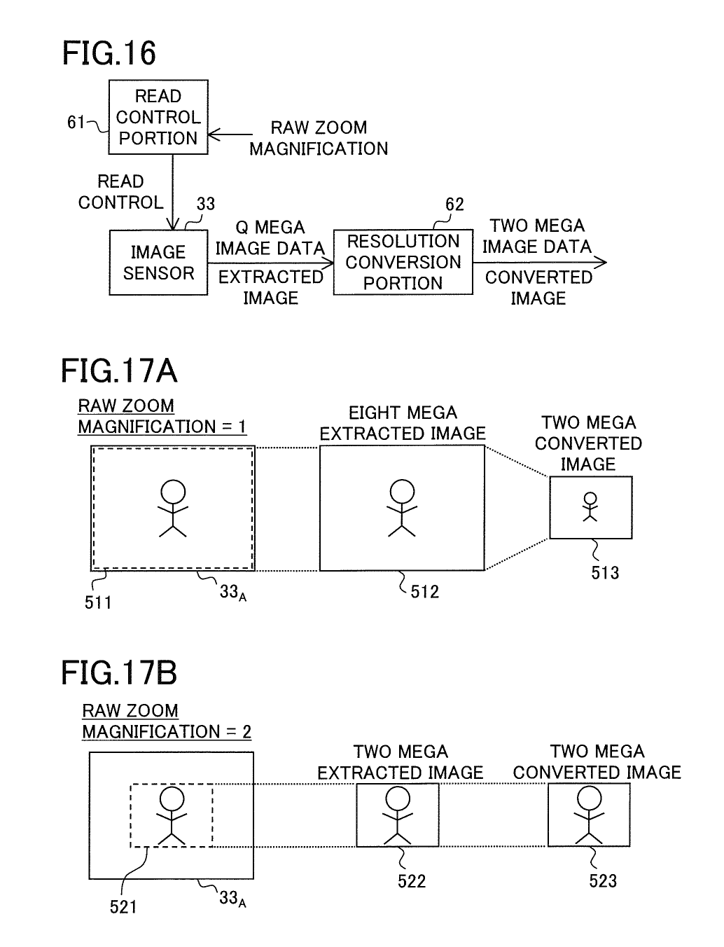

In the second example, RAW zoom is used instead of the electronic zoom described above in the first example. First, with reference to FIGS. 16, 17A, and 17B, the RAW zoom is described. A read control portion 61 and a resolution conversion portion 62 illustrated in FIG. 16 can be disposed in the main control portion 13 illustrated in FIG. 1. In the second example, for specific description, it is supposed that there are 4,000×2,000 light receiving pixels in the effective pixel region 33_{A} of the image sensor 33. In other words, in the effective pixel region 33_{A}, it is supposed that the number of light receiving pixels are 4,000 and 2,000 respectively in the horizontal and vertical directions. The number 1,000,000 is called a mega. Therefore, 4,000×2,000 is called also eight mega. In addition, the number of pixels in the horizontal and vertical directions of the output image defined by the above-mentioned specified output size are 2,000 and 1,000, respectively. Therefore, the specified output size is two mega.

In the electronic zoom in the first example, trimming is performed on the original image. In contrast, in the RAW zoom, trimming is performed on the image on the image sensor 33 when image data is read out from the image sensor 33. A magnification of trimming in the RAW zoom is referred to as a RAW zoom magnification.

The read control portion 61 controls data size or the like read out from the image sensor 33 in accordance with the RAW zoom magnification given to itself, and Q mega image data are read out from the image sensor 33 under this control. Here, Q is eight at largest. In addition, corresponding to the fact that an output definition size is two mega, a minimum value of Q is two. The two-dimensional image having a Q mega image size expressed by the Q mega image data read out from the image sensor 33 is referred to as an extracted image.

The resolution conversion portion 62 generates an image having a two mega image size by reducing an image size of the extracted image having a Q mega image size (hereinafter, the image having a two mega image size, which is generated by the resolution conversion portion 62, is referred to as a converted image). However, if Q is two, the extracted image itself becomes a converted image. Reduction of the image size is realized by a known resampling method. The angle of view of the extracted image having a Q mega image size is the same as the angle of view of the converted image having a two mega image size.

A relationship between the RAW zoom magnification and a value of Q is described with reference to a specific numeric example. When the RAW zoom is used, a rectangular extraction frame is defined with respect to the effective pixel region 33_{A} of the image sensor 33. It is supposed that the aspect ratio of the extraction frame is the same as that of the effective pixel region 33_{A}, and that the center of the extraction frame is the same as the center of the effective pixel region 33_{A}. FIG. 17A illustrates an extraction frame 511, an extracted image 512, and a converted image 513 when the RAW zoom magnification is one, and FIG. 17B illustrates an extraction frame 521, an extracted image 522, and a converted image 523 when the RAW zoom magnification is two. A variable range of the RAW zoom magnification is one or larger and 2 or smaller.

The read control portion 61 determines the image size of the extraction frame from the RAW zoom magnification according to the following definition equation.

$$RAW zoom magnification = 2 \times {( ( image size of converted image ) / ( image size of extraction frame ) )}^{1 / 2} = 2 \times {( ( two mega ) / ( image size of extraction frame ) )}^{1 / 2}$$

In other words, an image size of the extraction frame is determined so that a positive square root of a value obtained by dividing the image size of the converted image by the image size of the extraction frame becomes equal (or substantially equal) to a half of the RAW zoom magnification. Then, a light receiving pixel signal of each light receiving pixel in the extraction frame is read out from the image sensor 33 and supplied to the resolution conversion portion 62.

Therefore, when the RAW zoom magnification is one, the image size of the extraction frame becomes eight mega from the above-mentioned definition equation. Therefore, when the RAW zoom magnification is one, as illustrated in FIG. 17A, the extraction frame 511 having the same size as the effective pixel region 33_{A} is set. As a result, the extracted image 512 having an eight mega image size is read out. In this case, the resolution conversion portion 62 reduces the image size of the extracted image 512 by ½ in each of the horizontal and vertical directions, so as to generate the converted image 513 having a two mega image size.

When the RAW zoom magnification is two, the image size of the extraction frame becomes two mega from the above-mentioned definition equation. Therefore, when the RAW zoom magnification is two, as illustrated in FIG. 17B, the extraction frame 521 having a two mega image size is set in the effective pixel region 33_{A}. As a result, the extracted image 522 having a two mega image size is read out. In this case, the resolution conversion portion 62 outputs the extracted image 522 itself as the converted image 523.

As understood from the above-mentioned definition equation and FIGS. 17A and 17B, as the RAW zoom magnification becomes larger, the extraction frame becomes smaller so that the angle of view of the converted image becomes smaller. In other words, by increasing the RAW zoom magnification, it is possible to obtain an effect as if the optical zoom magnification or the electronic zoom magnification is increased. Further, if the RAW zoom magnification is larger than one, a read out amount of the signal from the image sensor 33 becomes smaller than eight mega, and hence power consumption for reading signal can be saved.

FIG. 18 is a block diagram of a portion related particularly to an action according to the second example. A zoom control portion 71 that sets the optical zoom magnification and the RAW zoom magnification from the output zoom magnification, an optical zoom processing portion 72 that performs the optical zoom by driving the zoom lens 30 in accordance with the optical zoom magnification set by the zoom control portion 71, a RAW zoom processing portion 74 that generates the target image by the RAW zoom with the RAW zoom magnification set by the zoom control portion 71, and an output image generating portion 75 that generates the output image by performing an image processing corresponding to the RAW zoom magnification on the target image can be disposed in the image pickup apparatus 1 (for example, the main control portion 13). The RAW zoom magnification is expressed by symbol ZF_{RAW}.

The zoom control portion 71 sets the optical zoom magnification and the RAW zoom magnification so that the equation ZF_{OUT}=ZF_{OPT}×ZF_{RAW} is satisfied. The optical zoom processing portion 72 is the same as the optical zoom processing portion 52 of FIG. 5.

The RAW zoom processing portion 74 includes the read control portion 61 and the resolution conversion portion 62 of FIG. 16 and outputs the converted image generated in the resolution conversion portion 62 as the target image.

The output image generating portion 75 has the same function as the output image generating portion 55 of FIG. 5. However, the output image generating portion 75 uses the RAW zoom magnification ZF_{RAW} instead of the electronic zoom magnification ZF_{EL} (namely, it regards the RAW zoom magnification ZF_{RAW} as the electronic zoom magnification ZF_{EL}) and performs the specific image processing including the blurring process described above in the first example, so that the output image is obtained from the target image.

FIG. 19 illustrates a relationship among magnifications ZF_{OPT}, ZF_{RAW}, and ZF_{OUT} supposed in the second example. FIG. 19, a bent line 531 indicates a relationship between ZF_{OPT} and ZF_{OUT}, and a bent line 532 indicates a relationship between ZF_{RAW} and ZF_{OUT}. The relationship among the magnifications ZF_{OPT}, ZF_{EL}, and ZF_{OUT} according to the bent lines 531 and 532 is referred to as a magnification relationship 530. The magnification relationship 530 is similar to the relationship illustrated in FIG. 15. In other words, in the magnification relationship 530, when 1≦ZF_{OUT}≦4 holds, ZF_{OPT}=ZF_{OUT} and ZF_{RAW}=1 are satisfied. When 4<ZF_{OUT}≦10 holds, relational equation ZF_{OUT}=ZF_{OPT}×ZF_{RAW} is satisfied while ZF_{OPT} is increased from 4 to 5 linearly, and simultaneously ZF_{RAW} is increased from 1 to 2 linearly, along with an increase of ZF_{OUT} from 4 to 10.

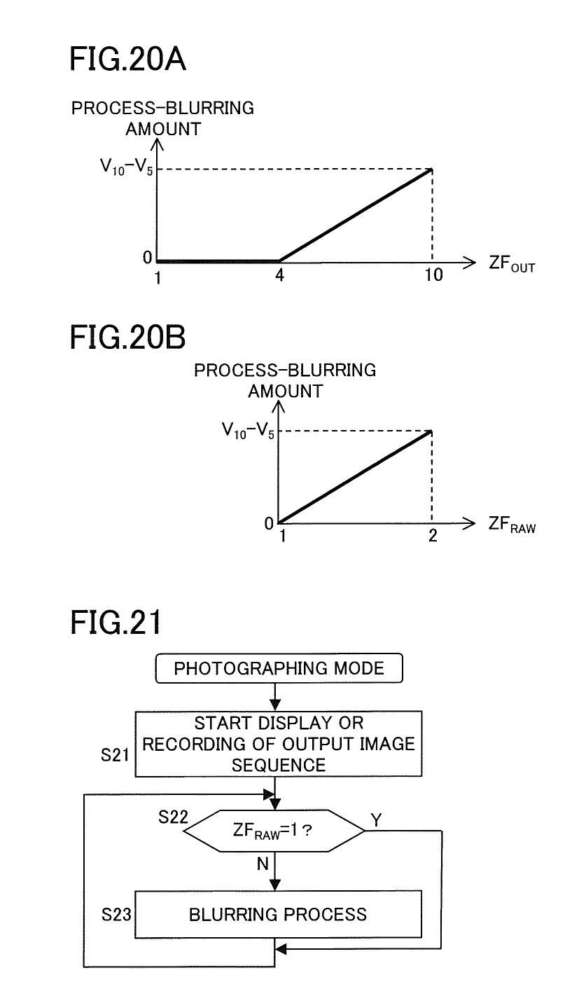

Similarly to the output image generating portion 55 of FIG. 5, the output image generating portion 75 sets the process-blurring amount using the blur amount characteristic information 450 of FIG. 11. FIG. 20A illustrates a relationship between the output zoom magnification ZF_{OUT} and the process-blurring amount, and FIG. 20B illustrates a relationship between the RAW zoom magnification ZF_{RAW} and the process-blurring amount. In the second example, a relationship between the output zoom magnification ZF_{OUT} and the target blur amount on the output image is the same as that of the first example (see FIG. 13).

As illustrated in FIGS. 20A and 20B, if the output zoom magnification is four or smaller, namely if the RAW zoom magnification is one, the process-blurring amount is set to zero. In other words, if ZF_{RAW} is one, the output image generating portion 75 does not perform the blurring process on the target image but outputs the target image as it is as the output image. On the other hand, if the output zoom magnification is larger than four, namely if the RAW zoom magnification is larger than one, the output image generating portion 75 performs the blurring process on the target image and outputs the target image after the blurring process as the output image. Along with an increase of the output zoom magnification, namely along with an increase of the RAW zoom magnification, the process-blurring amount is increased. Specifically, for example, the output image generating portion 75 sets the process-blurring amount and performs the blurring process based on the RAW zoom magnification ZF_{RAW} and the blur amount characteristic information 450, so that the target blur amount on the output image is the same as V_{7.5} when ZF_{OUT} is 7.5, and that the target blur amount on the output image is the same as V₁₀ when ZF_{OUT} is 10. Therefore, the process-blurring amount when ZF_{RAW} is two corresponds to V₁₀-V₅.

With reference to a flowchart of FIG. 21, an action procedure of the image pickup apparatus 1 in the photographing mode is described. When the image pickup apparatus 1 is powered on, subjects are photographed sequentially at a predetermined frame period, and display of the output image sequence is started (Step S21). When the recording instruction is issued, the output image sequence is recorded. The output image sequence means a set of output images arranged in time sequence.

After starting display or recording of the output image sequence, the process of Steps S22 to S24 is repeated while continuing the display or recording of the output image sequence. The user can freely perform the zoom operation to instruct a change of the output zoom magnification at an arbitrary timing. The zoom control portion 71 resets the magnifications ZF_{OPT} and ZF_{RAW} in accordance with the relationship of FIG. 19 every time when the output zoom magnification is changed using the zoom button 21. In Step S22, it is decided whether or not the RAW zoom magnification ZF_{RAW} is one. If ZF_{RAW} is one, the output image is generated without performing the blurring process. If ZF_{RAW} is larger than one, the blurring process is performed in Step S23 on the target image obtained via the RAW zoom, so as to obtain the output image.

According to the second example, also in the case where the RAW zoom is used, a blur amount can be obtained as if the optical zoom is used for obtaining the blur amount. Therefore, the same effect as the first example can be obtained.

Note that the electronic zoom in the first example and the RAW zoom in the second example are one type of digital zoom for adjusting angles of view of the target image and the output image. In the digital zoom by the electronic zoom, the angles of view of the target image and the output image are adjusted by trimming of the original image. In contrast, in the digital zoom by the RAW zoom, the angles of view of the target image and the output image are adjusted by trimming of the image on the image sensor 33.

In addition, it is possible to deform the relationship of FIG. 19 in the second example by the opposite method to that for deforming the relationship of FIG. 9 to the relationship of FIG. 15 in the first example. In other words, if 1≦ZF_{OUT}≦5 holds, ZF_{OPT}=ZF_{OUT} and ZF_{RAW}=1 may be satisfied, and if 5<ZF_{OUT}≦10 holds, ZF_{OPT}=5 and ZF_{RAW}=ZF_{OUT}/5 may be satisfied.

In addition, in the above-mentioned example, output signals of all the light receiving pixels in the extraction frame (511 or the like of FIG. 17A) set on the image sensor 33 are read out individually. In this case, however, thinning-out reading or adding reading may be performed. When the thinning-out reading is used, output signals of only a part of the light receiving pixels among all the light receiving pixels in the extraction frame are read out from the image sensor 33. When the adding reading is used, in reading of output signals from the light receiving pixels in the extraction frame on the image sensor 33, light receiving pixel signals of a plurality of light receiving pixels are added so that one added signal generated from the light receiving pixel signals of the plurality of light receiving pixels is read out as image data of one pixel.

In addition, the RAW zoom, the electronic zoom and the optical zoom may be combined to generate the target image. In this case, the zoom control portion 71 sets the magnifications ZF_{OPT}, ZF_{EL}, and ZF_{RAW} from the output zoom magnification so that ZF_{OUT}=ZF_{OPT}×ZF_{EL}×ZF_{RAW} is satisfied, and it is preferred to dispose the electronic zoom processing portion 54 of FIG. 5 in the RAW zoom processing portion 74. Then, the converted image from the resolution conversion portion 62 (see FIG. 16) is supplied as the original image to the electronic zoom processing portion 54 in the RAW zoom processing portion 74, and the electronic zoom processing portion 54 performs the electronic zooming process corresponding to the magnification ZF_{EL} on the original image (the converted image) so as to generate the target image.

### Third Example

A third example of the present invention is described. In the third example, an action of the image pickup apparatus 1 in the reproducing mode is described.

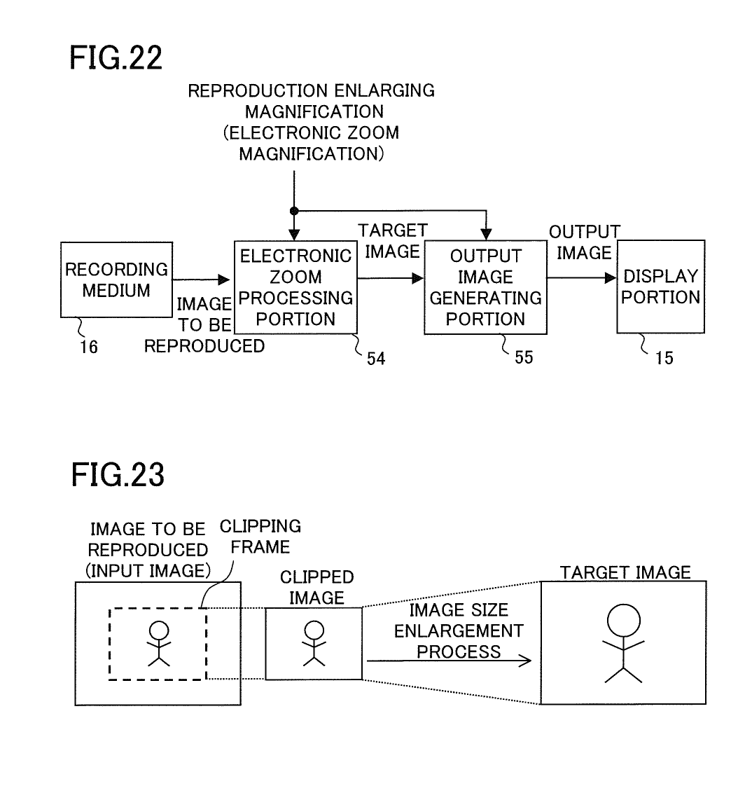

FIG. 22 is a block diagram of a portion related particularly to the action according to the third example. Among images recorded in the recording medium 16, an image designated by the user is read out as the image to be reproduced from the recording medium 16. The image to be reproduced as the input image is displayed on the display portion 15 after trimmed and enlarged according to a reproduction enlarging magnification designated by the user. For instance, the user can use the zoom button 21 to designate the reproduction enlarging magnification. The reproduction enlarging magnification is denoted by symbol EF_{REP}.

The electronic zoom processing portion 54 and the output image generating portion 55 of FIG. 22 have the same functions as those of FIG. 5. However, in the third example, the image to be reproduced and the reproduction enlarging magnification function as the original image and the electronic zoom magnification, respectively. The original image and the electronic zoom magnification described in the first example are read as the image to be reproduced and the reproduction enlarging magnification, respectively. Then, description in the first example can be applied to the electronic zoom processing portion 54 and the output image generating portion 55 of FIG. 22.

Therefore, the electronic zoom processing portion 54 of FIG. 22 uses the reproduction enlarging magnification as the electronic zoom magnification and performs the electronic zooming process on the image to be reproduced (the input image) so as to generate the target image. Here, it is supposed that a variable range of the reproduction enlarging magnification is one or larger and five or smaller. More specifically, as illustrated in FIG. 23, the electronic zoom processing portion 54 of FIG. 22 sets the clipping frame having a size corresponding to the reproduction enlarging magnification in the image region of the image to be reproduced (the input image). Then, the electronic zoom processing portion 54 performs the image size enlargement process on the image in the clipping frame (clipped image) on the image to be reproduced, so as to generate the obtained image as the target image. When the reproduction enlarging magnification is larger than one, the angle of view of the target image is smaller than the angle of view of the image to be reproduced. Hereinafter, in the description of the third example, when simply referred to the electronic zoom processing portion 54 and the output image generating portion 55, they means the electronic zoom processing portion 54 and the output image generating portion 55 of FIG. 22.

The output image generating portion 55 performs the specific image processing corresponding to the reproduction enlarging magnification on the target image so as to generate the output image. The output image is displayed on the display portion 15. Similarly to the first example, the specific image processing in the third example includes the blurring process for blurring the image of the subject SUB_{B} on the target image, namely, the blurring process for blurring the image in the out-of-focus region B of the target image. However, the process-blurring amount in the blurring process is set by using the reproduction enlarging magnification instead of the output zoom magnification.

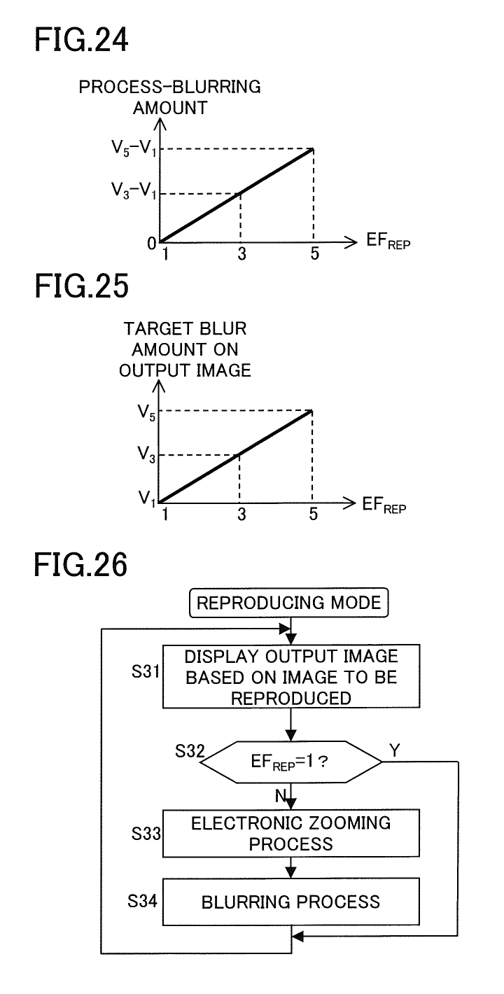

FIG. 24 illustrates a relationship between a reproduction enlarging magnification EF_{REP} and the process-blurring amount, and FIG. 25 illustrates a relationship between the reproduction enlarging magnification EF_{REP} and the target blur amount on the output image. Here, it is supposed that the image to be reproduced is the original image obtained when ZF_{OUT} is one.

As illustrated in FIG. 24, if the reproduction enlarging magnification is one, the process-blurring amount is set to zero. In other words, if EF_{REP} is one, the output image generating portion 55 does not perform the blurring process on the target image but outputs the target image as it is as the output image. Here, because it is supposed that the image to be reproduced is the original image obtained when ZF_{OUT} is one, the target blur amount on the output image is V₁ when EF_{REP} is one.

On the other hand, if the reproduction enlarging magnification is larger than one, the output image generating portion 55 performs the blurring process on the target image and outputs the target image after the blurring process as the output image. Along with an increase of the reproduction enlarging magnification, the process-blurring amount is increased. Specifically, for example, the output image generating portion 55 sets the process-blurring amount and performs the blurring process based on the reproduction enlarging magnification EF_{REP} and the blur amount characteristic information 450 so that the target blur amount on the output image is the same as V₃ when EF_{REP} is three, and that the target blur amount on the output image is the same as V₅ when EF_{REP} is five. Here, because it is supposed that the image to be reproduced is the original image obtained when ZF_{OUT} is one, the process-blurring amount when EF_{REP} is three corresponds to V₃-V₁, and the process-blurring amount when EF_{REP} is five corresponds to V₅-V₁.

Note that if the image to be reproduced is the original image obtained when ZF_{OUT} is not one, the process-blurring amount can be modified from that described above based on the optical zoom magnification when the image to be reproduced is photographed and on the blur amount characteristic information 450. However, if the target blur amount is a linear function of ZF_{OPT} in the blur amount characteristic information 450, this modification is not necessary.

In addition, as described above in the first example, it is preferred to determine the process-blurring amount for each pixel of the target image using the subject distance information in the third example, too. If the subject distance information is obtained only in the photographing mode, it is preferred to generate the subject distance information corresponding to the image to be reproduced in the photographing mode so as to record the subject distance information together with the image data of the image to be reproduced in the recording medium 16, and to read the corresponding subject distance information when image data of the image to be reproduced is read out.

With reference to a flowchart of FIG. 26, an action procedure of the image pickup apparatus 1 in the reproducing mode is described. In the reproducing mode, when any one of images recorded in the recording medium 16 is designated as the image to be reproduced, an output image based on the image to be reproduced is displayed on the display portion 15 in Step S31. Just after the image to be reproduced is designated, the reproduction enlarging magnification is set to one. As a result, the image to be reproduced is not enlarged but is displayed as it is as the output image on the display portion 15.

After that, the user can freely instruct a change of the reproduction enlarging magnification at an arbitrary timing. In Step S32 after Step S31, it is decided whether or not the reproduction enlarging magnification EF_{REP} is one. If EF_{REP} is one, the process goes back to Step S31 without performing the electronic zooming process and the blurring process, and the image to be reproduced is displayed as it is continuously as the output image on the display portion 15. On the other hand, if EF_{REP} is larger than one, in Steps S33 and S34, the electronic zooming process is performed on the image to be reproduced, and further the blurring process is performed to generate the output image. Then, the process goes back to Step S31. Therefore, if EF_{REP} is larger than one, a part of the image to be reproduced (a part of the input image) is enlarged according to the reproduction enlarging magnification, and the obtained image is displayed as the output image on the display portion 15.

According to the third example, when enlarging reproduction of an image is performed, a blur amount can be obtained as if the image is enlarged using the optical zoom. The enlarging reproduction also functions as substitute means for reducing the angle of view by the optical zoom that could not be performed or was not performed when the image was photographed. Therefore, when the angle of view is reduced by trimming for enlarging reproduction, the effect as if the angle of view adjustment is performed by the optical zoom has a large merit for a user.

Note that the image to be reproduced can be regarded as a still image, but it is possible to apply the technique described above in the third example to a moving image. In this case, it is preferred to supply the plurality of images to be reproduced that are arranged in time sequence to the electronic zoom processing portion 54 sequentially, and to generate the target image and the output image from each image to be reproduced so that the output image sequence is obtained. It is possible to display the obtained output image sequence as a moving image on the display portion 15 and to record the same in the recording medium 16.

### Fourth Example

A fourth example of the present invention is described. Similarly to the third example, in the fourth example too, an action of the image pickup apparatus 1 in the reproducing mode is described.

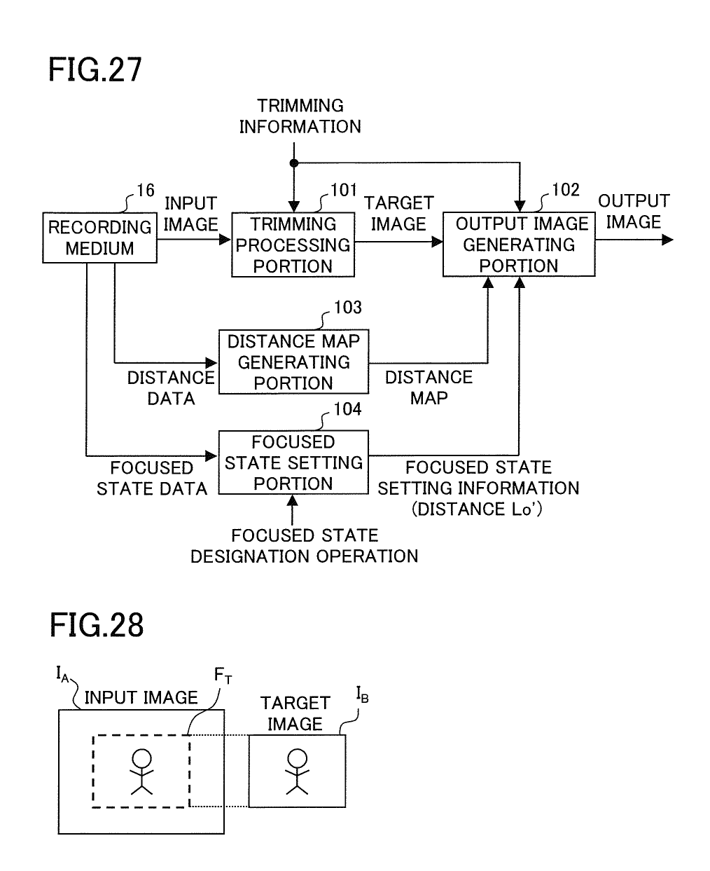

FIG. 27 is a block diagram of a portion related particularly to an action corresponding to the fourth example. The individual portions illustrated in FIG. 27 are disposed in the main control portion 13 of FIG. 1, for example. FIG. 28 illustrates the input image to a trimming processing portion 101 and the target image generated by the trimming processing portion 101. The input image and the target image in the fourth example are denoted by symbols I_{A} and I_{B}, respectively. Among images recorded in the recording medium 16, an image designated by the user is read out as the input image from the recording medium 16.

In FIG. 28, a frame F_{T} indicates the clipping frame. In the fourth example, the clipping frame is referred to as a trimming frame. The trimming processing portion 101 sets the trimming frame F_{T} in the image region of the input image in accordance with the trimming information and extracts the image in the trimming frame F_{T} as a target image I_{B}. It is possible to perform the image size enlargement process on the image in the trimming frame F_{T} for generating the target image I_{B} so that the image size of the target image I_{B} becomes the same as the image size of the input image I_{A}.

The trimming frame F_{T} corresponds to the clipping frame in the first to third examples, and the image in the trimming frame F_{T} (namely, the target image I_{B}) is a part of the input image I_{A}. Therefore, the angle of view of the target image I_{B} is smaller than the angle of view of the input image I_{A}.

The user can use the operating portion 17 or the touch panel 19 to perform a trimming instruction operation for designating a position, a size, and the like of the trimming frame F_{T}. Content of the designation by the trimming instruction operation is contained in the trimming information. The trimming information specifies the center position and sizes in the horizontal and vertical directions of the trimming frame F_{T} on the input image I_{A}. Here, it is supposed that the trimming frame F_{T} is a rectangular frame. However, it is possible to set the shape of the trimming frame F_{T} to other than the rectangular shape. The center position of the trimming frame F_{T} and the center position of the input image I_{A} may be the same or different. In addition, the aspect ratio of the trimming frame F_{T} and the aspect ratio of the input image I_{A} may also be the same or different.

An output image generating portion 102 performs the specific image processing corresponding to the trimming information based on the trimming instruction operation, a distance map from a distance map generating portion 103, and focused state setting information from a focused state setting portion 104 on the target image I_{B} so as to generate the output image. The specific image processing includes a blurring process similar to the above-mentioned blurring process (details will be described later). In addition, if the image size enlargement process has not been performed yet at time point when the target image I_{B} is generated, the image size enlargement process for setting the image size of the output image to be the same as the image size of the input image I_{A} can be included in the specific image processing. The output image can be displayed on the display portion 15 and can be recorded in the recording medium 16.

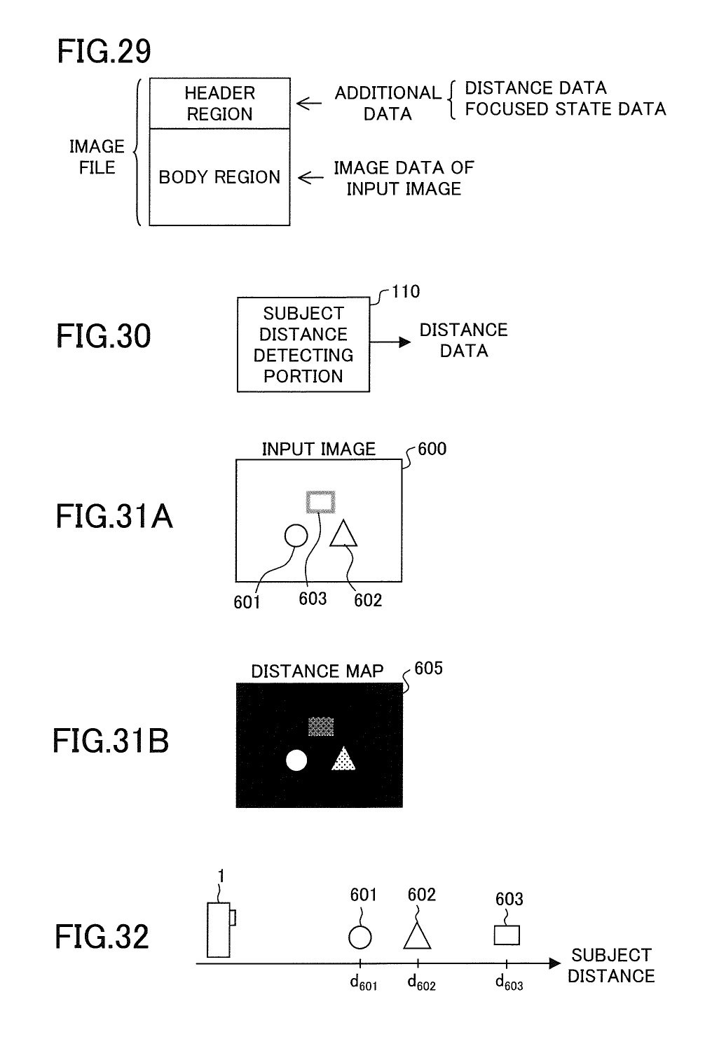

FIG. 29 illustrates a structure of an image file for storing image data of the input image. One or more image files can be stored in the recording medium 16. The image file has a body region for storing image data of the input image and a header region for storing additional data corresponding to the input image. The additional data contains various data concerning the input image including the distance data and the focused state data. The distance data is generated by a subject distance detecting portion 110 equipped to the main control portion 13 or the like (see FIG. 30). The subject distance detecting portion 110 detects a subject distance of a subject at each pixel of the input image and generates distance data indicating a result of the detection (a detected value of the subject distance of the subject at each pixel of the input image). As a detection method of the subject distance, arbitrary methods including known methods can be used. For instance, a stereo camera or a range sensor may be used for detecting the subject distance. Otherwise, the subject distance may be determined by an estimation process using edge information of the input image.

The distance map generating portion 103 reads out the distance data from the header region of the image file storing the image data of the input image and generates the distance map from the distance data. The distance map is a distance image (range image) in which each pixel value constituting the same has a detected value of the subject distance. The distance map specifies a subject distance of the subject at an arbitrary pixel in the input image or the target image. Note that the distance data itself may be the distance map. In this case, the distance map generating portion 103 is not necessary.

FIG. 31A illustrates an input image 600 as an example of the input image I_{A}, and FIG. 31B illustrates a distance map 605 corresponding to the input image 600. Image data of the subjects 601, 602, and 603 exist in the input image 600, and as illustrated in FIG. 32, it is supposed that the inequality 0<d₆₀₁<d₆₀₂<d₆₀₃ is satisfied among the subject distance d₆₀₁ of the subject 601, the subject distance d₆₀₂ of the subject 602, and the subject distance d₆₀₃ of the subject 603.

The focused state data stored in the header region illustrated in FIG. 29 is data specifying the focus reference distance Lo and the magnitude of the depth of field of the input image (see FIG. 3C) and is supplied to the focused state setting portion 104. Values of the distances Lo, Ln, and Lf may be supplied as the focused state data, or data for deriving the focus reference distance Lo and the magnitude of the depth of field of the input image such as the focal length and the aperture stop value of the image pickup portion 11 when the input image is photographed may be supplied as the focused state data.

The focused state setting portion 104 generates the focused state setting information based on the focused state data from the recording medium 16, or in accordance with a focused state designation operation by the user. The focused state setting information includes a distance Lo′ specifying the focus reference distance Lo of the output image, and the output image generating portion 102 performs the specific image processing so that the focus reference distance Lo of the output image becomes the same as the distance Lo′. The user can designate the distance Lo′ by the focused state designation operation as necessary. In this case, the user can use the operating portion 17 or the touch panel 19 so as to directly input a value of the distance Lo′. Alternatively, the user can designate the distance Lo′ by designation of a noted subject corresponding to the distance Lo′. For instance, if the subject distance of the subject 602 in the input image 600 is the distance Lo′, the image pickup apparatus 1 displays the input image 600 on the display portion 15, and in this state the user can use the touch panel 19 to designate the subject 602 on the display screen. When this designation is performed, the focused state setting portion 104 can set the subject distance of the subject 602 as the distance Lo′. If the user does not designate the distance Lo′, the specific image processing is performed so that the focus reference distance Lo determined by the focused state data from the recording medium 16, namely the focus reference distance Lo of the input image becomes the same as the focus reference distance Lo of the output image. In the following description, it is supposed that the user does not designate the distance Lo′ unless otherwise noted.

In the fourth example, for convenience sake, in the following description, it is supposed that the focus reference distance Lo is the center distance within the depth of field in the noted image 320 that is an arbitrary two-dimensional image (see FIGS. 3B and 3C). In other words, it is supposed that Lo=(Ln+Lf)/2 is satisfied.

The specific image processing in the fourth example includes the blurring process for blurring the out-of-focus distance subject image (namely, the image of the subject at the out-of-focus distance) included in the target image. In the noted image 320, the out-of-focus distance means a distance outside the depth of field of the noted image 320, and the out-of-focus distance subject (in other words, the subject at the out-of-focus distance) means a subject positioned outside the depth of field of the noted image 320. In addition, a difference between the focus reference distance Lo and a subject distance of an arbitrary subject is referred to as a difference distance.

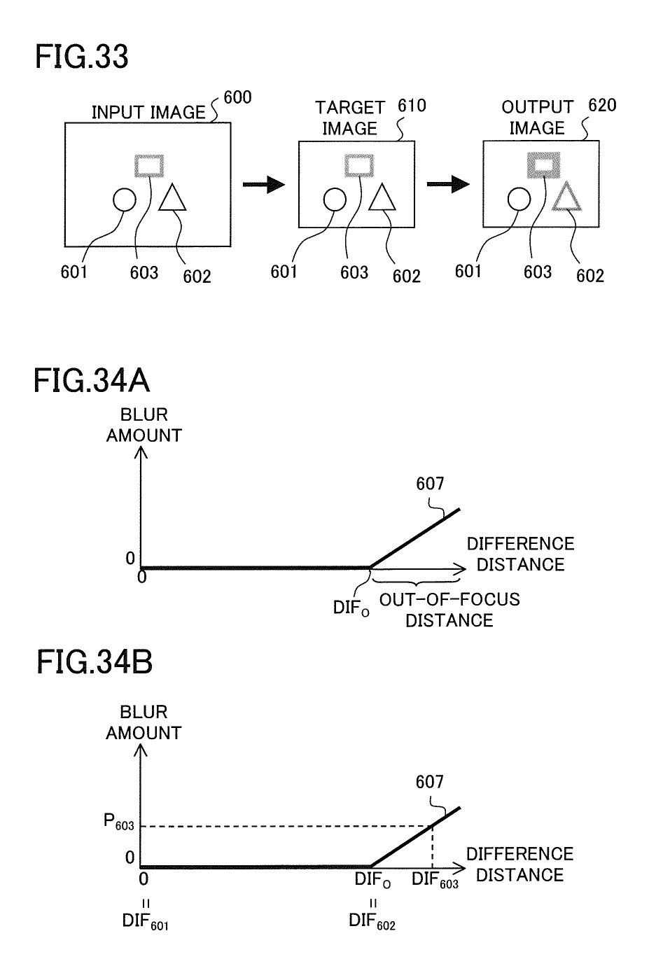

As illustrated in FIG. 33, the target image extracted from the input image 600 is referred to as a target image 610 and the output image based on the target image 610 is referred to as an output image 620. With reference to an example of the images 600, 610, and 620, the specific image processing in the fourth example is described. In FIG. 33, a degree of blur of the subject image is expressed by thickness of a contour line of the subject (the same is true in FIG. 31A).

In FIG. 34A, a bent line 607 indicates a relationship between the blur amount and the difference distance of each subject on the input image 600 or the target image 610. The distance DIF_{O} is a half the magnitude of the depth of field (namely, (Lf−Ln)/2) in the input image 600 or the target image 610. In the fourth example, a blur amount of the subject within the depth of field, namely a blur amount of an image having reference diameter of R_{REF} corresponding to the permissible diameter of circle of confusion or smaller is regarded as zero (see FIG. 3C). Then, as illustrated in FIG. 34A, in the input image 600 and the target image 610, the blur amount of the subject having a difference distance of the distance DIF_{O} or smaller is zero. The blur amount of the subject having a difference distance larger than the distance DIF_{O} is larger than zero, and the blur amount of the subject having a difference distance larger than the distance DIF_{O} increases along with an increase of the corresponding difference distance. In the input image 600 and the target image 610, a difference distance larger than the distance DIF_{O} is the out-of-focus distance.

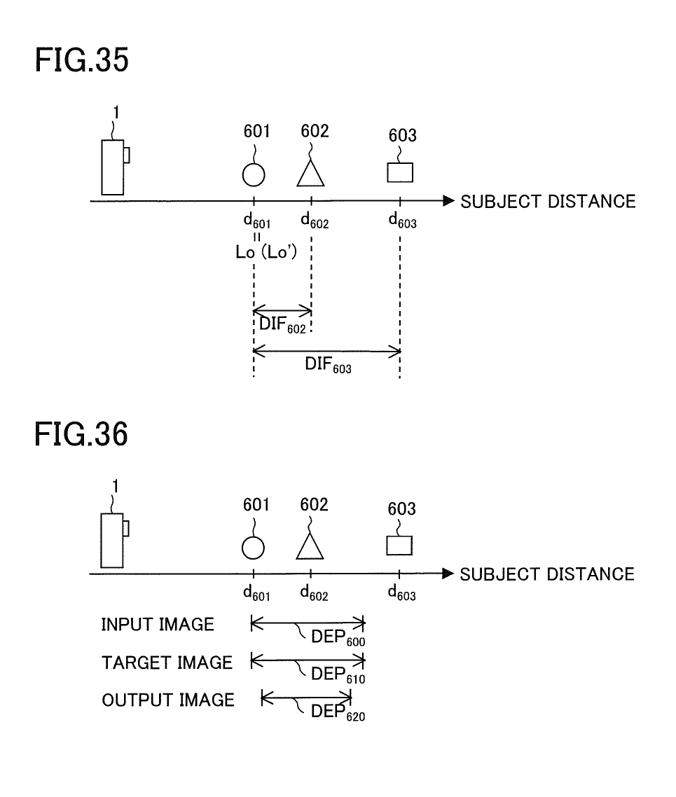

In the input image 600 and the target image 610, difference distances of the subjects 601, 602, and 603 are denoted by DIF₆₀₁, DIF₆₀₂, and DIF₆₀₃, respectively. Here, as illustrated in FIG. 35 (see FIG. 34B, too), it is supposed that the focus reference distance Lo of the input image 600 and the focus reference distance Lo of the output image 620 (namely, the distance Lo′) are the same as the subject distance d₆₀₁ (namely, DIF₆₀₁=0 holds), and DIF₆₀₁<DIF₆₀₂=DIF_{O}<DIF₆₀₃ is satisfied. Then, in the input image 600 and the target image 610, the subject 601 is the focused subject, and the subject 603 is the out-of-focus subject. Therefore, the blur amount of the subject 601 is zero, and the blur amount of the subject 603 is P₆₀₃ (P₆₀₃>0). In addition, because DIF₆₀₂ is equal to DIF_{O}, in the input image 600 and the target image 610, the subject 602 is a focused subject, and the blur amount of the subject 602 is zero.

In FIG. 36, ranges DEP₆₀₀, DEP₆₁₀, and DEP₆₂₀ indicate distance ranges of the depth of field of the input image 600, the target image 610, and the output image 620, respectively. The depth of field of the input image 600 is the same as that of the target image 610 as a matter of course, the depth of field of the output image 620 is set to be shallower than the depth of field of the target image 610 by the blurring process of the output image generating portion 102.

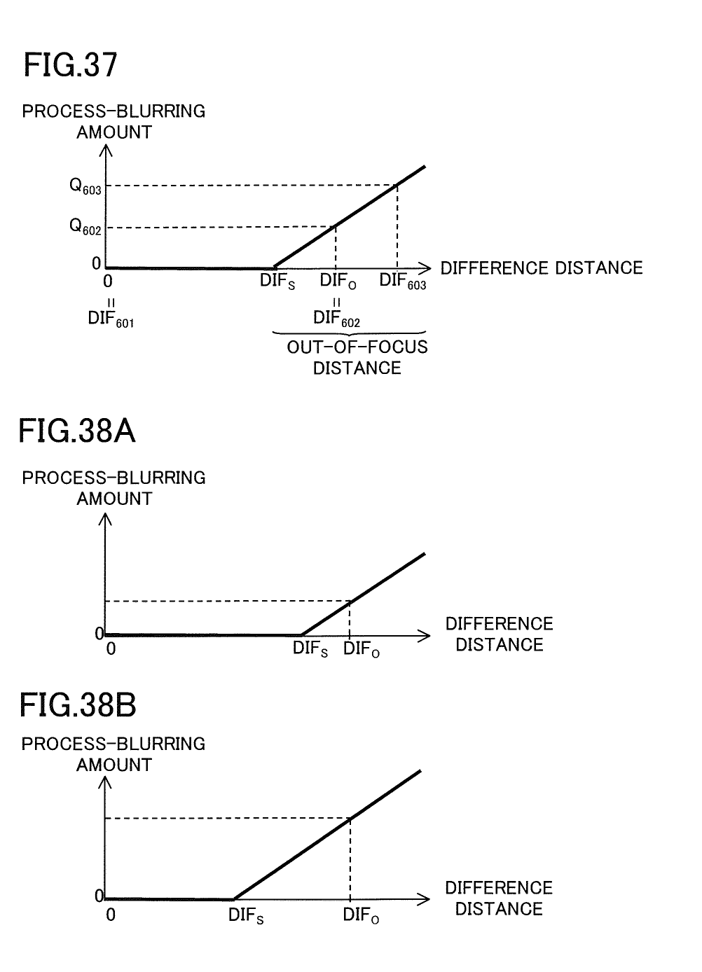

FIG. 37 illustrates a relationship between the process-blurring amount in the blurring process performed on the target image 610 and the difference distance. The output image generating portion 102 sets the process-blurring amount of each pixel of the target image 610 for each pixel based on the distance map and a size of the trimming frame included in the trimming information. In other words, the output image generating portion 102 sets the process-blurring amount of each subject of the target image 610 for each subject. More specifically, using the distance map and the distance Lo′ (Lo′=d₆₀₁ in this example), the output image generating portion 102 calculates the difference distance of each pixel of the target image 610, and sets the process-blurring amount of pixels corresponding to difference distances of the distance DIF_{S} or smaller (hereinafter, referred to as in-focus distance pixels) to zero, and sets the process-blurring amount of pixels corresponding to difference distances large than the distance DIF_{S} (hereinafter, referred to as out-of-focus distance pixels) to a value larger than zero. The in-focus distance pixel is a pixel in which image data of the focused subject on the output image 620 exist, and the out-of-focus distance pixel is a pixel in which image data of the out-of-focus subject on the output image 620 exist.

Here, because it is supposed that the focus reference distance Lo of the output image 620 is the same as the subject distance d₆₀₁, the subject 601 is a focused subject on the output image 620. In addition, because the depth of field of the output image 620 is shallower than those of the input image 600 and the target image 610, the subject 602 is an out-of-focus subject on the output image 620. The subject 603 is also an out-of-focus subject on the output image 620.

Meaning of the process-blurring amount and content of the blurring process corresponding to the process-blurring amount are the same as those described above in the first example. In other words, as the process-blurring amount set for the noted pixel is larger, the noted pixel is blurred more strongly in the blurring process (namely, as the process-blurring amount set for the noted subject is larger, the image of the noted subject is blurred more strongly in the blurring process). If the blurring process is realized by the spatial domain filtering using the smoothing filter, for example, it is preferred to increase a filter size of the smoothing filter (such as a Gaussian filter) to be used for the blurring process along with an increase of the process-blurring amount, and the increase of the filter size enhances blurring intensity.

In order to set the depth of field of the output image 620 shallower than the depth of field of the input image 600, the distance DIF_{S} corresponding to a half of the magnitude of the depth of field of the output image 620 is set shorter than the distance DIF_{O} corresponding to a half of the magnitude of the depth of field of the input image 600. Therefore, DIF_{S}<DIF_{O}=DIF₆₀₂<DIF₆₀₃ is satisfied. In addition, as for a pixel having a corresponding difference distance larger than the distance DIF_{S}, a larger process-blurring amount is set as the difference distance is larger. Therefore, when the process-blurring amount set for the subject 602 corresponding to the difference distance DIF₆₀₂ is denoted by Q₆₀₂, and when the process-blurring amount set for the subject 603 corresponding to the difference distance DIF₆₀₃ is denoted by Q₆₀₃, 0<Q₆₀₂<Q₆₀₃ is satisfied. Because 0<Q₆₀₂<Q₆₀₃ is satisfied, the images of the subject 602 and 603 are blurred in the specific image processing so that blur as illustrated in FIG. 33 is obtained. Note that as described above, in FIG. 33, a degree of blur of the subject image is expressed by a thickness of a contour line of the subject.

The subject distance d₆₀₂ is not the out-of-focus distance in the target image 610, but it becomes the out-of-focus distance in the output image 620 because the depth of field is reduced. Therefore, the specific image processing can be said to include the blurring process for blurring the image of the out-of-focus distance subject 603 in the target image 610, and further to include the blurring process for blurring images of the out-of-focus distance subjects 602 and 603 in the output image 620.

A decrease of a size of the trimming frame is similar to an increase of the reproduction enlarging magnification in the third example. The depth of field of the output image 620 is set shallower, and the process-blurring amount is increased, along with a decrease of a size of the trimming frame. Then, the blur amount can be obtained as if the optical zoom is performed.

In order to set the depth of field of the output image 620 shallower and to increase the process-blurring amount along with a decrease of a size of the trimming frame, the output image generating portion 102 decreases the distance DIF_{S} along with a decrease of a size of the trimming frame indicated by the trimming information. The decrease of the distance DIF_{S} causes an increase of the process-blurring amounts Q₆₀₂ and Q₆₀₃. In other words, the process-blurring amounts Q₆₀₂ and Q₆₀₃ increase along with a decrease of a size of the trimming frame. FIG. 38A illustrates a relationship between the difference distance and the process-blurring amount in the case where a size of the trimming frame is relatively large, and FIG. 38B illustrates a relationship between the difference distance and the process-blurring amount in the case where a size of the trimming frame is relatively small.

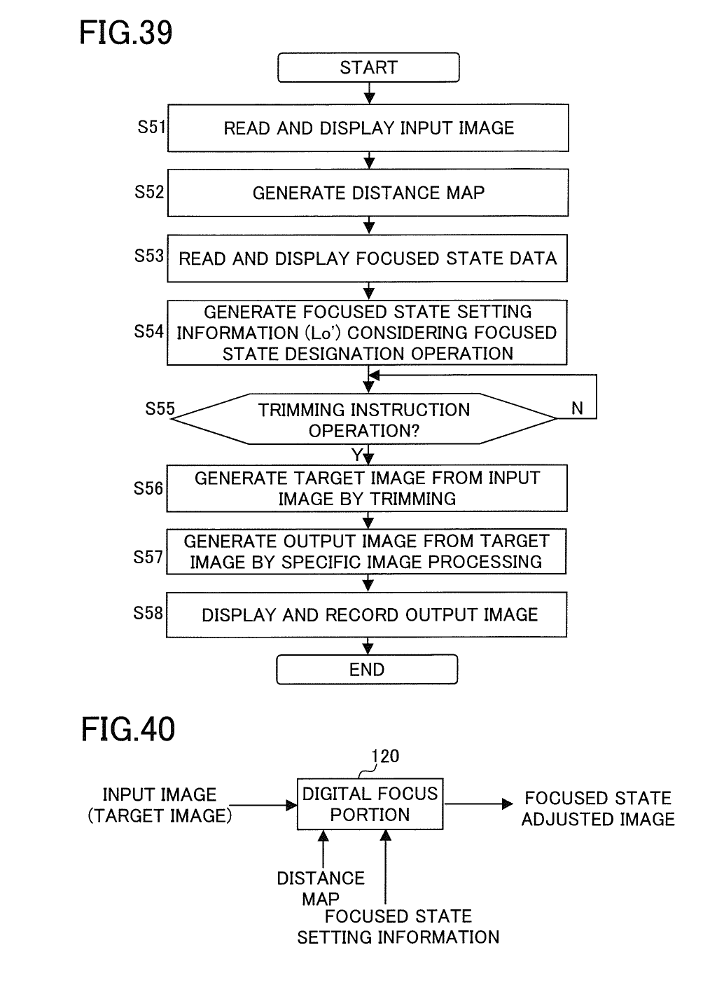

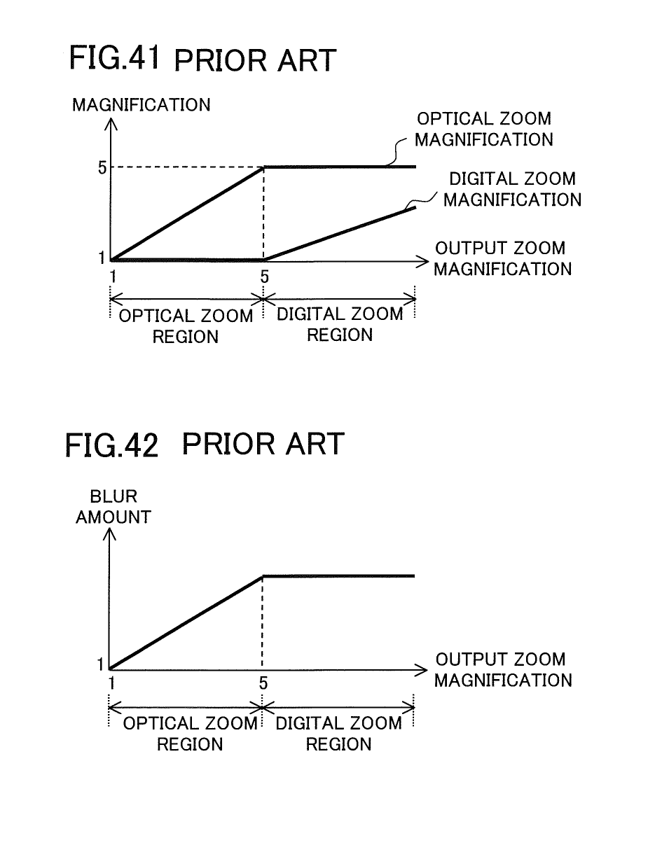

With reference to a flowchart of FIG. 39, an action procedure of the image pickup apparatus 1 in the reproducing mode is described. In the reproducing mode, when any one of images recorded in the recording medium 16 is designated as an input image, image data of the input image is read out from the recording medium 16 in Step S51, and the input image is displayed on the display screen. Further, in Steps S52 and S53, the distance data and the focused state data corresponding to the input image are read out from the recording medium 16, and the distance map is generated from the distance data while the focused state data is displayed. In this case, it is possible to display image information in an arbitrary form for the user to recognize the focus reference distance Lo and the magnitude of the depth of field of the input image (simply, for example, values of the distances Lo, Ln, and Lf).

In the next Step S54, the focused state setting portion 104 generates the focused state setting information including the distance Lo′ by the above-mentioned method, considering a focused state designation operation by user. After that, in Step S55, the image pickup apparatus 1 accepts the trimming instruction operation and performs the process of Steps S56 to S58 when the trimming instruction operation is performed. Note that it is possible to realize an action without considering an input of the focused state designation operation. In this case, the process of Steps S53 and S54 or the process of Step S54 is omitted, and the focus reference distance Lo of the input image is used as it is as the distance Lo′.

In Step S56, the target image is generated from the input image by trimming based on the trimming information. In the next Step S57, the depth of field of the target image is set shallow by the specific image processing corresponding to the trimming information, the distance map, and the focused state setting information, so as to generate the output image. In Step S58, the output image is displayed on the display screen, and image data of the output image is recorded in the recording medium 16. When the image data of the output image is recorded in the recording medium 16, it is possible to delete the image data of the input image from the recording medium 16 or to keep the image data of the input image in the recording medium 16.

Similarly to the third example, the blur amount can be obtained as if the optical zoom is performed in the fourth example too, when the image is trimmed. The image trimming also functions as substitute means for decreasing the angle of view by the optical zoom that could not be performed or was not performed when the image was photographed. Therefore, when the angle of view is decreased by the trimming, an effect as if the angle of view adjustment had been performed by the optical zoom can be obtained, which will be a great merit for the user.

Note that the input image can be considered as a still image, but it is possible to apply the technique described above in the fourth example to a moving image. In this case, it is preferred to supply the plurality of input images arranged in time sequence to the trimming processing portion 101 sequentially, and to generate the target image and the output image from each input image so as to obtain the output image sequence. It is possible to display the obtained output image sequence as a moving image on the display portion 15 and to record the same in the recording medium 16.

In addition, it is also possible that the magnitude of the depth of field (hereinafter, referred to also as a depth DEP) can be designated by the focused state designation operation. Specifically, for example, it is possible to form the image pickup apparatus 1 so that the arbitrary focus reference distance Lo and the depth DEP can be designated by the focused state designation operation. The designated focus reference distance Lo and depth DEP are denoted by Lo* and DEP*, respectively. When the designation of them is performed, a digital focus portion 120 in the main control portion 13 (see FIG. 40) may perform the digital focus on the input image based on the distance map and the focused state setting information including Lo* and DEP*, so as to change the focus reference distance Lo and the depth DEP of the input image to the focus reference distance Lo* and the depth DEP*. In other words, it is possible to generate the focused state adjusted image having Lo* and DEP* as the focus reference distance Lo and the depth DEP from the input image by the digital focus. When this focused state designation operation is performed in Step S54 of FIG. 39, the above-mentioned focused state adjusted image may be displayed between Steps S54 and S55. When the user resets the focus reference distance Lo* and the depth DEP* between Steps S54 and S55, the focused state adjusted image may be regenerated in accordance with the reset focus reference distance Lo* and depth DEP*.

In addition, if the digital focus portion 120 is disposed in the main control portion 13, the digital focus based on the distance map and the focused state setting information (including Lo* and DEP*) may be performed on the target image. According to this, the focus reference distance Lo and the depth DEP of the target image are changed to the focus reference distance Lo* and the depth DEP*, so that the result image is obtained as the output image. In other words, by performing the digital focus on the target image, it is possible to obtain the focused state adjusted image as the output image, which has Lo* and DEP* as the focus reference distance Lo and the depth DEP, and has the same angle of view as the target image. In this case, it can be said that the digital focus functions as the specific image processing and that the digital focus portion 120 functions as the output image generating portion 102.

The digital focus is the image processing that can adjust the depth of field of the image to be processed, which is the input image or the target image, to an arbitrary value. The adjustment of the depth of field includes adjustment (change) of the focus reference distance Lo and the depth DEP. By the digital focus, it is possible to generate the focused state adjusted image having an arbitrary focus reference distance Lo and an arbitrary magnitude of the depth of field DEP from the image to be processed.

As the image processing method for realizing the digital focus, various image processing methods are proposed. The digital focus portion 120 can utilize a known digital focus image processing (for example, image processing described in JP-A-2010-252293, JP-A-2009-224982, JP-A-2008-271241, or JP-A-2002-247439).

### Variations

The embodiment of the present invention can be modified appropriately and variously in the scope of the technical concept described in the claims. The embodiment described above is merely an example of the embodiment of the present invention, and the present invention and the meanings of terms of the elements are not limited to those described in the embodiment. Specific numerical values exemplified in the above description are merely examples, which can be changed to various values as a matter of course. As annotations that can be applied to the embodiment described above, Notes 1 to 4 are described below. The descriptions in the Notes can be combined arbitrarily as long as no contradiction arises.

[Note 1]

The specific image processing in each example described above may include image processing other than the blurring process. For instance, the specific image processing may include a contour emphasizing process for emphasizing contours of focused subjects (namely, an edge enhancement process for enhancing edges of focused subjects).

[Note 2]

The image pickup apparatus 1 described above may be constituted of hardware or a combination of hardware and software. If the image pickup apparatus 1 is constituted using software, the block diagram of a portion realized by software indicates a functional block diagram of the portion. The function realized using software may be described as a program, and the program may be executed by a program executing device (for example, a computer) so that the function can be realized.

[Note 3]

The image pickup apparatus 1 in the reproducing mode functions as an image reproduction apparatus. The action of the image pickup apparatus 1 in the reproducing mode may be performed by an image reproduction apparatus (not shown) other than the image pickup apparatus 1. The image reproduction apparatus includes an arbitrary information apparatus such as a mobile phone, a mobile information terminal, or a personal computer. Each of the image pickup apparatus and the image reproduction apparatus is one type of electronic equipment. In addition, it can be said that the image pickup apparatus 1 includes the image processing apparatus. The image processing apparatus in FIG. 5 includes the original image obtaining portion 53, the electronic zoom processing portion 54, and the output image generating portion 55. The image processing apparatus in FIG. 18 includes the RAW zoom processing portion 74 and the output image generating portion 75. The image processing apparatus in FIG. 22 includes the electronic zoom processing portion 54 and the output image generating portion 55. The image processing apparatus in FIG. 27 includes the trimming processing portion 101, the output image generating portion 102, the distance map generating portion 103, and the focused state setting portion 104.

[Note 4]

For instance, it is possible to consider as follows. In the first example, a part including the original image obtaining portion 53 and the electronic zoom processing portion 54 illustrated in FIG. 5 can be called a target image generating portion. In the second example, the RAW zoom processing portion 74 of FIG. 18 functions as the target image generating portion. In the third example, the electronic zoom processing portion 54 of FIG. 22 functions as the target image generating portion. In the fourth example, the trimming processing portion 101 of FIG. 27 functions as the target image generating portion.

What is claimed is:

1. An image pickup apparatus comprising:
a target image generating portion that generates a target image by photography using optical zoom and digital zoom; and
an output image generating portion that generates an output image by performing image processing on the target image, wherein
an entire image region of the target image includes a first image region and a second image region having a focus degree lower than that of the first image region,
the image processing includes a blurring process for blurring an image in the second image region of the target image, and
the output image generating portion performs the blurring process in accordance with a magnification of the digital zoom.

2. The image pickup apparatus according to claim 1, wherein the output image generating portion increases a blurring amount of the blurring process along with an increase of the magnification of the digital zoom.

3. The image pickup apparatus according to claim 2, wherein the output image generating portion sets the process-blurring amount based on a relationship between magnification of the optical zoom and a blur amount of the image within the second image region, which are observed when the target image is generated by using only the optical zoom.

4. An image reproduction apparatus comprising:
a target image generating portion that generates a target image by enlarging an input image in accordance with a designated reproduction enlarging magnification;
an output image generating portion that generates an output image by performing image processing on the target image; and
a display portion that displays the output image, wherein
an entire image region of the target image includes a first image region and a second image region having a focus degree lower than that of the first image region,
the image processing includes a blurring process for blurring an image in the second image region of the target image, and
the output image generating portion performs the blurring process in accordance with the reproduction enlarging magnification.

5. The image reproduction apparatus according to claim 4, wherein the output image generating portion increases a blurring amount of the blurring process along with an increase of the reproduction enlarging magnification.

6. An image processing apparatus comprising:
a target image generating portion that sets a clipping frame for designating a part of an input image and extracts an image in the clipping frame so as to generate a target image; and
an output image generating portion that performs image processing on the target image so as to generate an output image, wherein
the image processing includes a blurring process for blurring an image of a subject at an out-of-focus distance, and
the output image generating portion performs the blurring process in accordance with a size of the clipping frame.

7. The image processing apparatus according to claim 6, wherein the output image generating portion increases a blurring amount of the blurring process along with a decrease of the size of the clipping frame.
